(19) United States
(12) Patent Application Publication
(10) Pub. No.: US 2007/0244709 A1
(43) Pub. Date: Oct. 18, 2007

(54) Methods of producing and recycling plastic cards

(75) Inventor: Rodd S. Gilbert, Solon, OH (US)

Correspondence Address: FAY SHARPE LLP, 1100 SUPERIOR AVENUE, SEVENTH FLOOR, CLEVELAND, OH, 44114, US

(73) Assignee: Earthworks Systems, LLC

(21) Appl. No.: 11/541,823

(22) Filed: Sep. 29, 2006

Related U.S. Application Data
(63) Continuation-in-part of application No. 11/405,300, filed on Apr. 17, 2006.

(51) Int. Cl. G06Q 10/00; G06Q 30/00

(52) U.S. Cl. 705/1

(57) ABSTRACT

Methods for recovering plastic cards for recycling and converting into plastic cards comprising recycled scrap material. Plastic cards may be recovered by providing a receptacle to a first party, such as a retailer, for collecting plastic cards, such as transaction cards, that would normally be discarded. Arrangements may be made with a second service, such as a transport service, to collect the receptacle(s) from the first party and deliver them to a third party, such as a recycler, to be recycled (optionally into new plastic card stock and/or plastic cards). Methods for advertising on plastic cards are also provided.

This application is a continuation-in-part of U.S. patent application Ser. No. 11/405,300, filed Apr. 17, 2006.

### BACKGROUND

The present application broadly relates to methods of recycling and producing plastic cards and, more particularly, methods of recycling used plastic cards and methods of producing transaction cards associated with a first party that bear an indicia of a second party, which is unrelated to the first party.

Plastic cards are becoming more prevalent in a variety of applications. Therefore, as the number of cards being produced increases, the amount of scrap material resulting from processing plastic cards and from discarded plastic cards themselves continues to increase. It is estimated that over 18 million tons of plastic waste is produced every year, and it is estimated that at least about 400,000,000 lbs. of that waste is attributable to the production and/or use of plastic cards, such as transaction, information and identification cards, for example. Ongoing efforts are being made to improve the quality of the environment by maximizing the usage of virgin polymeric materials during manufacturing operations and minimizing the generation of scrap and/or other waste materials.

For example, the manufacturing processes used to prepare plastic cards, such as transaction cards (e.g., credit cards, gift cards and debit cards), identification cards (e.g., driver licenses, membership cards, and security badges), information cards (e.g., promotional and marketing cards), and other plastic cards, including those having information stored thereon, such as on a magnetic strip, for example, result in significant production of scrap material in addition to the desired product. Such scrap or waste material can include set-up sheets, edge trim, skeletons from punching and/or die cutting, hole slugs, discarded product due to quality or overruns, waste from high dies, round corner waste, sheets rejected from lamination, waste sheets from printing and/or butt rolls of overlay, for example.

Conventional or standard plastic card manufacturing processes typically involve the production of relatively large, unfinished stock sheets of polymeric material. This unfinished sheet stock is normally sized to allow a plurality of plastic cards to be cut therefrom. The unfinished sheet stock is produced using any one of a variety of known manufacturing processes, such as calendaring or extruding, for example. The unfinished sheet stock is typically then cut and/or trimmed into finished sheets of stock that are sized to customer specifications or are of appropriate dimensions for further processing.

Presently, virgin polyvinyl chloride (virgin PVC) is the material of choice for use in the manufacture of plastic card stock and plastic cards. Other virgin homopolymeric and/or co-polymeric materials may alternately be used in some card applications. The use of virgin PVC is due at least in part to the durability and price of virgin PVC, as compared to other virgin plastic materials. However, the use of virgin material exclusively or even in a substantial or large quantity is problematic for several reasons. One reason is that the use of virgin PVC can still significantly contribute to the cost of an associated product, though it may be more economical than other virgin materials. Additionally, environmentally unfriendly additives are normally used to achieve the desired sheet or card properties and/or characteristics. Furthermore, such additives further contribute to manufacturing costs and can also introduce issues related to quality control.

For decorative, informational or other purposes, the trimmed or sized stock sheets of virgin PVC or other virgin polymers are commonly printed or otherwise at least partially coated with an ink or other marking substance. Optionally, a clear coating of ink, lacquer or another substance can be applied over the printing to seal and/or otherwise protect the same. This arrangement is particularly well suited for lower cost sheets and/or cards, such as might be used for or as promotional or advertising cards, for example.

As an alternative to clear coating, trimmed or sized stock sheets, with or without printing, can be combined with a protective overlay, such as one that includes a pre-applied magnetic strip, for example.

In one known arrangement, the overlay can include a pre-applied dry adhesive that is suitable for bonding to the specific ink or other marking substances deposited on the sheet stock or card. The use of dry adhesive is often desirable as the ink or other marking substance can undesirably influence adhesion between the virgin PVC core and the overlay. In other arrangements, however, the adhesive may be applied directly over the ink. An overlay with or without adhesive could then be applied to the trimmed sheet or plastic card on top of the pre-applied adhesive.

These various card layers form a sandwich construction, and these “sandwiches” are inserted between mirrored plates of steel, which creates books of sandwiches and plates. The books are then inserted into vertical lamination presses that use heat and pressure to combine the sandwiches into laminated sheets of card stock. After the lamination process, the individual cards can be punched out of or otherwise formed from the laminated sheets of card stock in any suitable manner, such as by machines that are designed to handle laminated sheets, including those with uneven edges. One example of such equipment uses optical sensors to locate specific card features prior to the punching or other card separation process.

Once a plastic card is cut or otherwise separated from a laminated sheet of card stock, the plastic card may be considered finished. In other arrangements, suitable post-processing steps may be performed to further refine the card. Such post-processing steps can include hot stamping, personalization (e.g., applying names and/or numbers to the card surface and/or encoding a magnetic strip on the card), embossing, punching and scoring (i.e., providing additional internal or edge punching or cutting), for example.

Presently, the scrap material resulting from the various processing steps utilized to produce a plastic card is not known to be recycled to make sheets of plastic card stock or plastic cards. Similarly, the plastic cards themselves are not typically recycled. Rather, the cards are simply discarded after they are used for their intended purpose. Because plastic cards are simply being discarded by consumer and retailers, new plastic cards are normally manufactured from virgin material. As discussed above, there are numerous disadvantages to this arrangement.

FIG. 17 illustrates one example of a current system 50 for processing and/or using plastic cards. As shown in FIG. 17, virgin polymeric material, such as virgin polyvinyl chloride, for example, is provided, as indicated by box 52, and manufactured or processed into card stock material, such as a plastic sheet, as indicated by box 54. Individual cards are cut, punched, separated or otherwise formed from the card stock sheets, as indicated by box 56. After a card is separated from a sheet, the card may undergo post processing steps including, for example, hot stamping, personalization, embossing, scoring, or the like. Plastic cards are then provided to third parties, such as retailers, consumers or other parties, as indicated by box 58, to be used for various applications including, but not limited to use as transaction cards, information cards or identification cards, for example.

As shown in FIG. 17, scrap material may be produced at every step in conventional manufacturing processes for producing sheets of plastic card stock as well as the use of plastic cards. This scrap is generally discarded as waste WST or otherwise rendered unavailable or unusable. For example, the manufacturing or production of the sheet material 54 produces scrap 60 as a natural consequence of, for example, calendaring or extrusion processes that are typically employed to produce the sheet material. Additionally, scrap 62 results from the formation of plastic cards 56, and may include material such as set up sheets, edge trim, or skeletons from punch and/or die cutting, for example. Post-processing of the sheet of card stock, as indicated by box 64, and/or post-processing of plastic cards, as indicated by box 66, may also produce scrap indicated by boxes 68 and 70, respectively. Such scrap can include waste sheets from printing, for example. Furthermore, scrap 68 and/or 70 may also result from product overruns and/or discarded products that fails certain quality standards, for example. Further still, post-consumer handling of plastic cards 58 typically further generates scrap material 72, as the plastic cards are simply discarded after they are used for their intended purpose. Thus, the plastic cards themselves typically become waste WST deposited in a landfill or otherwise unusably disposed. As shown in FIG. 17, the scrap material, such as 60, 62, 68, 70 and/or 72, for example, is reduced to waste WST and disposed of in a manner rending the same unavailable or unsuitable for further use.

### BRIEF DESCRIPTION

In view of the foregoing, it is desirable to provide a section of plastic material, such as a sheet of plastic card stock and/or a plastic card, that comprises a reduced amount of virgin polymeric material relative to conventional constructions. Along these lines, it is desirable to provide sheets of plastic card stock and/or plastic cards constructed, at least in part, from a material comprising recycled polymeric scrap material. Additionally, it is desirable to provide a process or method for manufacturing sheets of plastic card stock and/or plastic cards that comprises utilizing and/or recycling scrap polymeric material to produce sheets of plastic card stock and/or plastic cards comprising the recycled scrap polymeric material. Furthermore, it is desirable to provide a method of recycling plastic card stock and/or plastic cards into sheets of plastic card stock and/or plastic cards.

In one embodiment in accordance with the present disclosure, a section of polymeric sheet material is provided comprising a first layer having a first surface and a second surface, the first layer being constructed from a first material comprising recycled scrap material from a single family of polymeric materials.

In another embodiment, a method of manufacturing one of a sheet of plastic card stock or a plastic card is provided, the method comprising (a) recovering scrap polymeric material; (b) regrinding the scrap polymeric material to provide recycled polymeric particles; (c) processing the recycled polymeric particles to form a section of polymeric sheet material comprising recycled scrap polymeric material; and (d) forming at least one of a sheet of plastic card stock or a plastic card from the section of polymeric sheet material.

In still another embodiment, a method for forming one of a sheet of plastic card stock or a plastic card comprising recycled scrap material is provided, the method comprising (a) recovering scrap polymeric material from a source; (b) regrinding the scrap polymeric material to provide recycled scrap polymeric particles; (c) processing the recycled scrap polymeric particles to form a section of polymeric sheet material comprising recycled scrap material; and (d) forming one of a sheet of plastic or a plastic card comprising recycled scrap material.

In yet another embodiment, a method for recycling scrap polymeric material into one of a sheet of plastic card stock or a plastic card is provided, the method comprising (a) recovering scrap polymeric material from a first party; (b) regrinding the scrap polymeric material into recycled scrap polymeric particles; (c) processing the recycled scrap polymeric particles into a section of polymeric sheet material comprising recycled scrap polymeric material; (d) processing the section of polymeric sheet material into at least one of a sheet of plastic card stock or a plastic card comprising recycled scrap polymeric material; and (e) distributing the at least one sheet of plastic card stock or plastic cards to a second party.

One exemplary embodiment of a section of material in accordance with the present novel concept is provided that includes a sheet of plastic card stock or a plastic card comprising recycled scrap material that is recovered from conventional plastic card manufacturing processes or post-consumer scrap. The plastic card may be a single layer comprising only a homogenous core of recycled scrap material or a blend of a virgin polymeric material and recycled scrap material. The plastic card may also be multi-layered, comprising a combination of homogenous or heterogeneous core materials (as a single layer or multiple layers), along with such other virgin material layers (veneers), protective overlays, additives, magnetic strips and ink or other marking substances as are desired for a particular application.

One exemplary method of manufacturing a sheet of plastic card stock or a plastic card is provided that includes recovering scrap polymeric material from a plastic card manufacturing process. The exemplary method also includes at least one of grinding, shredding or pulverizing the scrap material into plastic particles. The exemplary method further includes utilizing the plastic particles in one of a calendaring, extruding or co-extruding process to create a solid core of recycled scrap material suitable for use in forming a sheet of plastic card stock or a plastic card. The exemplary method can also optionally includes applying a veneer and/or an overlay along one or both sides of the solid core.

One exemplary method of manufacturing a sheet of plastic card stock or a plastic card is provided that includes recovering post-consumer scrap from third parties, such as retailers and/or consumers, for example, who place such plastic cards into use. The exemplary method also includes at least one of grinding, shredding or pulverizing the post-consumer scrap material into plastic particles. The exemplary method further includes utilizing the plastic particles in one of a calendaring, extruding or co-extruding process to create a solid core of recycled scrap material suitable for use in forming a sheet of plastic card stock or a plastic card. The exemplary method can optionally include applying a veneer and/or an overlay along one or both sides of the solid core.

In view of the earlier discussed problems and disadvantages, it is also desirable to provide a method of recycling plastic cards, such as used transaction, information and/or identification cards, for example. Along these lines, it is desirable to collected or arrange for collection of plastic cards and to transfer or arrange for transfer of at least the plastic cards to a party for recycling. In one aspect, a method of recycling plastic cards includes providing or arranging for the provision of a receptacle suitable for storing a plurality of plastic cards; collecting or arranging for the collection of at least one plastic card and storing or arranging for storage of the at least one plastic card in the receptacle; and transporting or arranging for transport of at least one plastic card to a recycler or a party that will facilitate or enable recycling of the plastic cards, such as into recycled polymeric scrap material, for example.

It may also be desirable to arrange, such as by contracting, for example, with a transport service to retrieve receptacles together with any plastic cards therein and transport the receptacles with any plastic cards to a party or facility for recycling. The receptacle can optionally be formed from a material suitable for recycling together with any plastic cards therein, and can optionally be recycled together with such plastic cards. Further, it may be desirable to arrange, such as by contracting, with a transport service or other parties participating in the collection and/or transportation of plastic cards to have recycled cards marked with an indicia identifying the transport service and/or other parties.

In one embodiment, a method of recycling plastic cards includes arranging for a first party to collect used plastic cards from one or more second parties. The method also includes arranging for transfer of the used plastic cards from the first party to a third party. The method further includes arranging for recycling of the used plastic cards into recycled polymeric scrap material by the third party.

In another embodiment, a method of recovering used transaction cards includes: one of providing and arranging for provision of a receptacle suitable for receiving and retaining used transaction cards; one of collecting and arranging for collection of at least one used transaction card and one of storing and arranging for storage of the at least one used transaction card in the receptacle; and one of transporting and arranging for transport of the at least one transaction card from the point of collection or storage to a facility for recycling.

In still another embodiment, a method of recycling used transaction cards includes one of providing and arranging for the provision of a card receptacle to a provider of at least one of goods or services, with the card receptacle being suitable for receiving and storing used transaction cards. The method also includes one of collecting and arranging for collection of at least one used transaction card from a purchaser of at least one of goods or services from the provider. The purchaser at least partially compensating the provider for the at least one of goods or services using a transaction card having non-zero monetary value associated therewith and thereby generating a used transaction card having an approximately zero monetary value associated therewith. The method further includes one of storing and arranging for storage of the at least one used transaction card in the card receptacle by the provider. The method also includes one of transporting and arranging for transportation by a transporter of the at least one used transaction card to a first recycler. The method still further includes one of regrinding and arranging for regrinding of the at least one used transaction card into recycled polymeric scrap material by said first recycler. The method also includes one of processing and arranging for processing by one of said first recycler or a second recycler of the recycled polymeric scrap material into polymeric sheet material capable of use in forming new plastic cards.

In a further embodiment, a method of recycling used transaction cards includes: (a) providing a receptacle to a retailer for collecting at least one transaction card; (b) collecting at least one transaction card in the receptacle; (c) contracting with a transport service to collect the receptacle comprising the at least one transaction card and transport the receptacle to a recycler; (d) transporting the receptacle to the recycler; (e) contracting with the recycler for regrinding the at least one used transaction card into recycled polymeric scrap material; (f) processing the recycled polymeric scrap material into a section of polymeric sheet material; (g) contracting with a producer for processing the section of polymeric sheet material into at least one of a plastic card stock or a plastic card comprising recycled scrap polymeric material; and (h) distributing the at least one of the sheet of plastic card stock or plastic cards to a further party.

It is also desirable to provide a method of advertising on plastic cards, such as transaction cards. One exemplary method of providing advertising on a plastic card includes contracting to provide, or have provided, plastic cards to a first party that utilizes plastic cards in one or more functions of its business; contracting with a second party to have the first party's plastic cards marked with an indicia identifying or otherwise associated with the second party; obtaining the indicia from the second party; and producing or arranging to have produced plastic cards for the first party bearing the indicia of the second party. The method can also optionally include arranging for a compensation to be remitted by the second party, such as, for example, remitting a portion of the compensation to the first party and/or to another party associated with producing (which can include arranging for production of) the plastic cards.

In one embodiment, a method of presenting external-party indicia on transaction cards associated with a provider of at least one of goods or services includes: a) one of contracting and arranging a contract with a provider to supply thereto a plurality of transaction cards bearing an indicia of the provider and an indicia of an external party; b) one of contracting and arranging a contract with an external party for presentation of an indicia associated with the external party on the plurality of transaction cards in exchange for compensation to at least one of the provider or a party associated with supplying the plurality of transaction cards to the provider; c) one of producing and arranging for production of the plurality of transaction cards bearing the indicia of the provider and the indicia of the external party; and, d) one of distributing and arranging for distribution of the plurality of transaction cards to at least the provider.

In another embodiment, a method of providing advertisements on a plastic card includes providing advertisements on a transaction card of a retailer and comprises contracting with a retailer to provide at least one transaction card to the retailer; contracting with at least one third-party supplier to the retailer to place an indicia identifying the third-party supplier on at least one transaction card of the retailer; and producing at least one transaction card that includes an indicia of the third-party supplier thereon.

In a further embodiment, a method of providing advertisements on a transaction card of a retailer includes: contracting with a retailer to provide a first set of transaction cards and a second set of transaction cards to the retailer; contracting with a first set of third-party suppliers to the retailer to place indicia identifying each third-party supplier in the first set of third-party suppliers on a first plurality of transactions cards of the retailer. The first set of third-party suppliers comprising at least one third-party supplier. The method also includes: producing the first plurality of transaction cards bearing the indicia of the first set of third-party suppliers; contracting with a second set of third-party suppliers to the retailer to place indicia identifying each third-party supplier in the second set of third-party suppliers on a second plurality of transactions cards of the retailer. The second set of third-party suppliers comprising at least one third-party supplier. The method further includes: producing the second plurality of transaction cards bearing the indicia of the second set of third-party suppliers. The first set of third-party suppliers and the second set of third-party suppliers being different from one another.

### BRIEF DESCRIPTION OF THE DRAWINGS

These and other features, aspects and advantages will become better understood with regard to the following description, appended claims and accompanying drawings. The drawings are not to scale and the proportion of certain elements may be exaggerated for the purposes of clarity and ease of illustration.

FIG. 1 is a top view of a length of unfinished sheet stock illustrating representations of a sheet of plastic card stock and a plurality of plastic cards formable therefrom;

FIG. 2 is a cross-sectional side view of one exemplary embodiment of a section of plastic material suitable for use as a sheet of card stock or a plastic card as shown in FIG. 1 and including a single core comprising recycled scrap material;

FIG. 3 is a cross-sectional side view of an alternate embodiment of the section of plastic material in FIG. 2 that includes a single core comprising recycled scrap material and an overlay on one surface of the core;

FIG. 4 is a cross-sectional side view of another alternate embodiment of the section of plastic material in FIG. 2 that includes a single core comprising recycled scrap material and a veneer on one surface of the core;

FIG. 5 is a cross-sectional side view of still another alternate embodiment of the section of plastic material in FIG. 2 that includes a single core comprising recycled scrap material, a veneer on one surface of the core and an overlay on the outer surface of the veneer;

FIG. 6 is a cross-sectional side view of a further alternate embodiment of the section of plastic material in FIG. 2 that includes a multi-layered core comprising recycled scrap material;

FIG. 7 is a cross-sectional side view of still a further alternate embodiment of the section of plastic material in FIG. 2 that includes a multi-layered core comprising recycled scrap material and an overlay on one surface of the multi-layered core;

FIG. 8 is a cross-sectional side view of yet a further alternate embodiment of the section of plastic material in FIG. 2 that includes a multi-layered core comprising recycled scrap material and a veneer on one surface of the multi-layered core;

FIG. 9 is a cross-sectional side view of another alternate embodiment of the section of plastic material in FIG. 2 that includes a multi-layered core comprising recycled scrap material, a veneer on one surface of the multi-layered core and an overlay on the outer surface of the veneer;

FIG. 10 is a cross-sectional side view of another alternate embodiment of the section of plastic material in FIG. 2 that includes a single core comprising recycled scrap material, and a scratch-off label disposed along one surface of the core;

FIG. 11 is a representation of one exemplary process of forming a sheet of plastic card stock and/or a plastic card comprising recycled scrap material;

FIG. 12 is a representation of one exemplary process for recycling plastic card material into a section of plastic material comprising the recycled card material;

FIG. 13 is a representation of one exemplary process of recovering plastic cards, transporting recovered cards, and recycling recovered cards into a section of plastic material comprising the recycled card material;

FIG. 14 is a perspective view of one exemplary embodiment of a receptacle suitable for receiving and storing plastic cards;

FIG. 15 is a representation of one exemplary method for providing advertising on transaction cards;

FIG. 16 is a representation of one exemplary method providing advertising on transaction cards comprising recycled scrap material; and,

FIG. 17 illustrates an example of a conventional process for producing a plastic card and generating scrap material waste.

### DETAILED DESCRIPTION

The following includes definitions of selected terms employed herein. The definitions include various examples and/or forms of components and/or actions that fall within the scope of a term and that may be used for implementation. The examples are not intended to be limiting. Both singular and plural forms of terms may be within the definitions.

“Overlay,” as used herein, refers to a substantially transparent, relatively thin layer of virgin polymeric material suitable for use in the manufacture of a plastic card. The overlay can be adhered by heat, pressure and/or adhesive to a core of recycled scrap material, virgin polymeric material, and/or combinations thereof or to a veneer as described herein. The overlay can optionally contain a pre-applied magnetic strip and/or a pre-applied adhesive as may be desired for a particular application.

“Plastic card” and “plastic card stock,” as used herein, refer to any approximately flat section of polymeric material of any suitable size, shape or thickness. A plastic card will normally have a smaller relative size than a sheet of plastic card stock. Plastic cards can be used for any suitable purpose and can include any suitable features or elements. For example and without limitation, plastic cards can be used as transaction cards (e.g., credit cards, gift cards, debit cards), identification cards (e.g., driver licenses, membership cards, security badges, key tags, luggage tags) and/or information cards (e.g., business cards, marketing or promotional cards). A sheet of plastic card stock is generally of a larger relative size than that of plastic cards and, for example, may be dimensioned such that one or more plastic cards could be formed from the plastic material within the boundaries thereof. Additionally, a sheet of plastic card stock and/or a plastic card can include a single polymeric layer or multiple polymeric layers. The one or more layers that comprise a sheet of plastic card stock or a plastic card can be constructed of a virgin polymeric material, recycled scrap material, and/or combinations thereof.

“Scrap polymeric material,” as used herein, refers to any previously processed, used, spent or otherwise discarded polymeric material including, but not limited to, scrap resulting from processing virgin polymeric material and/or recycled scrap material, scrap resulting from the manufacture of a sheet of plastic card stock or from the manufacture of plastic cards, and/or post-consumer scrap recovered from third parties, such as in the form of spent or discarded plastic cards, for example. It will be appreciated that “scrap polymeric material” includes any polymeric material from a class or family of polymeric material that may be used to form a core for a sheet of plastic card stock and/or for a plastic card including, but not limited to, non-ethylenic olefin polymers or polyolefins, polyamides, polyvinyl chlorides, polystyrenes, nylon, polyesters, polyestercopolymers, polyurethanes, polyacrylates, polysulfones, styrene-maleic anhydride copolymers, styrene-acrylonitrile copolymers, ionomers based on sodium or zinc salts of ethylene methacrylic acid, polymethyl methacrylates, fluoroplastics, polycarbonates, polyacrylonitriles, polycyanurates, ethylene-vinyl acetate copolymers, and combinations thereof. Some specific examples of suitable polymeric materials that are used in card stock and may become “recycled scrap material,” or “scrap polymeric material” include, but are not limited to, polypropylene (PP) and/or the rigid PVC family.

“Recycled scrap material” or “recycled polymeric scrap material,” as used herein, refers to scrap polymeric material that has been recovered from an earlier use and processed into a form that is suitable for further use in later manufacturing applications and/or processes. For example “recycled polymeric scrap material” includes, but is not limited to, scrap polymeric material that is reground into particles for subsequent processing, and individual classes or families of polymeric material that are separated or otherwise recovered from an article comprising a mixture of polymeric materials.

“Veneer,” as used herein, refers to a relatively thin layer of polymeric material, such as, for example, virgin polymeric material, suitable for use in the manufacture of a plastic card. The veneer can be adhered by heat, pressure and/or adhesive to a core of recycled scrap material, virgin polymeric material, and/or combinations thereof.

“Regrinding,” as used herein, refers to any process that may be employed to act upon scrap material to produce a sufficiently fine particle size to render the scrap material fit for use in subsequent polymeric processing methods. For example, “regrinding” includes, but is not limited to, grinding, shredding, pulverizing, and the like. The particle size produced from regrinding is not limited except to the extent that the particles should be of a size sufficient or suitable for use in a polymeric processing operation such as, for example, extrusion or calendaring processes. Particle sizes desirable or suitable for use in a particular process are readily ascertainable by a person skilled in the art.

“Transaction card,” as used herein, refers to a card that may be used in place of cash to purchase goods or services from a source. Transaction cards include, for example, cards such as credit cards and debit cards. “Transaction cards” also include stored valued cards, such as gift cards, having a certain monetary value stored on or in association with the card, and wherein the value is decreased as purchases are made. Credit cards, debit cards, and stored value cards are non-limiting examples of transaction cards, and it will be appreciated that other types of cards will qualify as transaction cards.

“Used transaction card” or “spent transaction card,” as used herein, refers to a transaction card that (i) has expired, such as, for example, in the case of credit or debit cards, (ii) previously had a non-zero monetary value associated therewith but which non-zero monetary value has been reduced such that the transaction card has an approximately zero monetary value associated therewith, and/or (iii) is otherwise unusable as a transaction card.

“Provider,” as used herein, includes any entity that provides goods and/or services and which accepts transaction cards as a suitable method for an external party to pay for the goods or services provided. One example of a provider is a “retailer” that sells goods and/or services to “customers” and receives payment for such goods and/or services, such as by way of transaction cards, for example. Another example of a provider is a “wholesaler” that sells goods and/or services, such as to retailers, distributors and/or service professionals, for example, and that receives payment for such goods and/or services, such as by way of transaction cards, for example. Another example of a provider is a “manufacturer” that deals directly with consumers as well is with wholesalers, distributors and/or retailers, for example, and that receives payment for such goods and/or services, such as by way of transaction cards, for example.

“External party,” as used herein, refers to an entity that produces or supplies goods and/or services to a provider for sale and/or distribution by or at the direction of the provider. An external party does not include any entity that is related through direct or common ownership to the provider. That is, an external party cannot own or be owned, in part or in whole, by the provider. Additionally, the external party and provider cannot be commonly owned by a parent entity or organization.

As one example, a retailer of home repair tools and materials might stock and sell a wide variety of products, such as paints, lumber, plumbing supplies, hand and power tools, for example, that are supplied thereto by “third-party suppliers” that are external parties. The paints may be supplied by a first external party, the lumber may be supplied by a second external party, the plumbing supplies may be supplied by a third external party, and the hand and power tools may be supplied by a fourth external party. Each of the external parties are third-party suppliers that are unrelated to the retailer.

“Recycler,” as used herein refers to any entity engaged in physically recycling plastic materials, such as plastic cards. Additionally the process of recycling plastic materials may include processing by any number of one or more “recyclers.” For example, a first recycler may regrind scrap material into recycled polymeric scrap material with a second recycler forming sheet material from the recycled polymeric scrap material. “Recycler” can also include any outside party or entity that arranges or facilitates the recycling of scrap polymeric material by a physical processor of such material.

From time to time, this application may use the ordinals “first,” “second,” “third,” “fourth,” etc. to identify a step, party, object, or the like, in describing various aspects of plastic cards, or the various methods in accordance with the present disclosure. It will be appreciated that, unless otherwise stated, such ordinals are used for convenience to differentiate or identify separate items in a given object, method, example, or claim. Such ordinals are not intended to be limiting in any manner, and do not limit the number of items, parties, etc. that may be present in any plastic card or method in accordance with the present disclosure.

This application describes numerous embodiments of a section of polymeric material that is suitable for use as or for use in forming a sheet of plastic card stock or a plastic card that is constructed, at least in part, from a material comprising recycled polymeric scrap material. For example, in one embodiment, a section of polymeric material that is suitable for use as or for use in forming a sheet of plastic card stock or a plastic card can be constructed from a material comprising a blend of virgin polymeric material and recycled polymeric scrap material. In another embodiment, a section of polymeric material that is suitable for use as or for use in forming a sheet of plastic card stock or a plastic card can be constructed from a material consisting essentially of recycled polymeric scrap material. In still a further embodiment, a section of polymeric material that is suitable for use as or for use in forming a sheet of plastic card stock or a plastic card can be constructed from a material consisting of recycled polymeric scrap material. A material “comprising,” “consisting essentially of,” or “consisting of” recycled scrap material is not limited to recycled scrap material from a particular class or family of polymeric materials or a particular source, but may include blends of recycled scrap material from one or more polymeric classes or families or scrap source.

As mentioned above, a plastic card and/or a sheet of plastic card stock can include a single layer or multiple layers, which include one or more core layers and can optionally include one or more veneer layers and/or one or more overlay layers. In an exemplary embodiment, at least one or more of the core layer or layers is at least partially formed from recycled polymeric scrap material, which among other benefits can reduce the cost of manufacturing plastic cards and/or plastic card stock and can reduce the overall environmental impact of the production of the same.

The recycled polymeric scrap material can include any suitable type, kind, family or group of polymer, including blends and/or mixtures thereof, that might find use in a conventional or standard plastic card manufacturing process. It will be appreciated that recycled scrap polymeric material may comprise a single family or class of polymeric material, or a blend of polymeric materials from different families or classes of polymeric material. In one embodiment recycled scrap polymeric material comprises a single family or class of polymeric materials. A single family or class of polymeric materials encompasses compositions comprising a single type of polymer. For example, a vinyl polymer, such as rigid polyvinyl chloride, can be used. Additionally, a single family or class of polymeric materials encompasses compositions comprising of blend of polymeric materials from a single family or class of polymeric material. For example, a composition comprising a single class or family of polymeric materials may include two or more different types of polyolefins. The above examples are merely for illustration and are not limiting examples of suitable polymeric material compositions.

Additionally, the recycled polymeric scrap material may also include a relatively minor amount of additives, metallic substances, laminates, inks and other substances that comprise the initial sheet of plastic card stock or that may have been added to fit the manufacturer's particular purpose. In one embodiment, to the extent they exist in the plastic card, the veneers and/or overlays are constructed of the same family of polymeric material as the recycled polymeric scrap material. However, it is conceivable that they may be constructed of a different family of polymeric material. Depending on the application, the size and thickness of the plastic cards may vary widely.

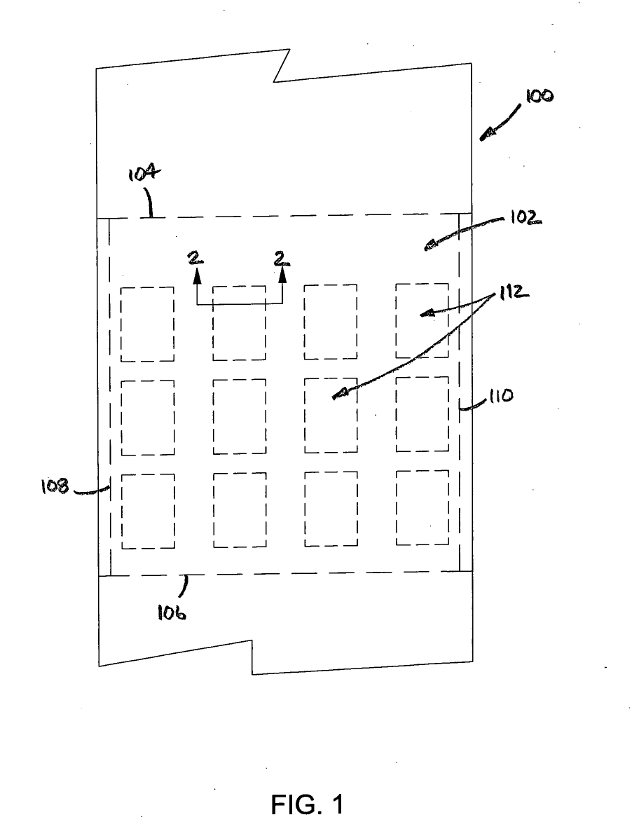

FIG. 1 is a top plan view of one exemplary embodiment of a length of unfinished sheet stock 100 formed from material comprising recycled polymeric scrap material. The unfinished sheet stock is suitable for use in forming a sheet of plastic card stock 102 from a section of polymeric material disposed between first and second trim lines 104 and 106. Optionally, sheet 102 can be further sized and/or shaped by cutting or trimming additional portions of the section of polymeric material, such as along additional third and fourth trim lines 108 and 110. The unfinished sheet stock is also suitable for use in forming one or more plastic cards 112. The plastic cards can be cut to an approximate size or shape directly from a section of polymeric material from unfinished sheet stock 100 or alternately from sheet 102, such as after further processing operations thereof, for example.

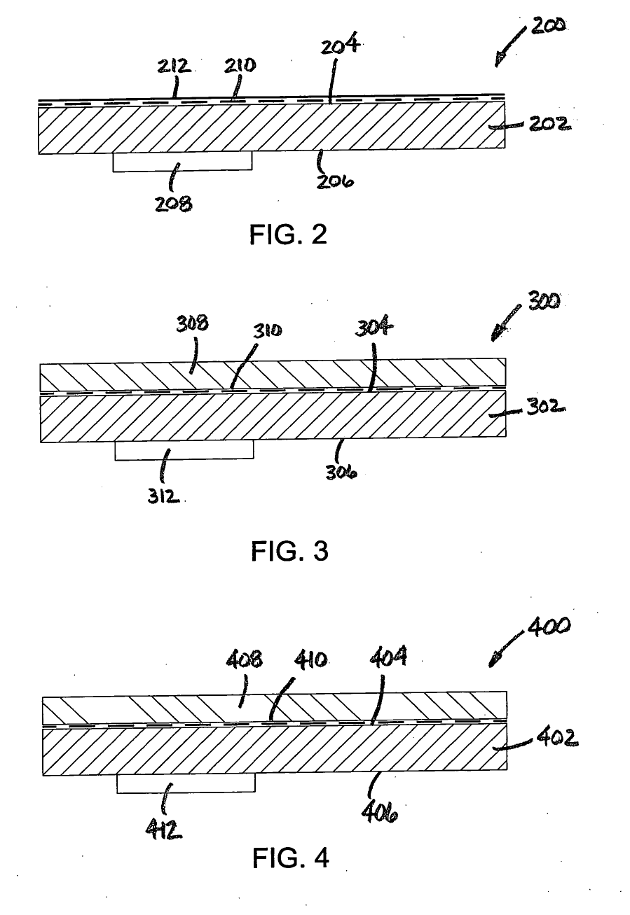

FIG. 2 is a cross-sectional side view of one embodiment of a section of polymeric material 200 that is suitable for use as a sheet of plastic card stock or a plastic card. Section of polymeric material 200 includes a first layer 202 having a first or top surface 204 and an opposing second or bottom surface 206. In one exemplary embodiment, first layer 202 can be constructed of a material comprising recycled scrap material. In another embodiment, first layer 202 can be constructed of a material comprising a mixture of recycled scrap material and virgin polymeric material.

Optionally, an information storage device can be provided on or along either one or both surfaces of the first layer. In the exemplary embodiment shown, a magnetic strip 208 is shown disposed along bottom surface 206. It will be appreciated, however, that any other suitable construction can alternately be used. Additionally, printing or marking can be provided on or along one or both of surfaces 204 and 206 of first layer 202. In the exemplary embodiment shown, printing 210 is disposed along first surface 204. An optional clear coating 212, such as ink, lacquer or another suitable substance, for example, can be applied along one or both of surfaces 204 and 206. In one exemplary embodiment, such an optional clear coating 212 extends over any printing or marking that may be included, such as printing 210, for example.

It will be appreciated that a core sheet or card may be a single ply comprising a section of polymeric material. For example, referring to FIG. 2, a core sheet or card could simply comprise a first layer such as layer 202 having a top surface 204 and an opposing or bottom surface 206, without any optional clear coating, veneer overlayer, etc., disposed over the top or bottom surface.

FIG. 3 is a cross-sectional side view of another embodiment of a section of polymeric material 300 that is suitable for use as a sheet of plastic card stock or a plastic card. Section of polymeric material 300 includes a first layer 302 having a first or top surface 304 and an opposing second or bottom surface 306. In one exemplary embodiment, first layer 302 can be constructed of a material comprising recycled scrap material. In another embodiment, first layer 302 can be constructed of a material comprising a mixture of recycled scrap material and virgin polymeric material.

In the exemplary embodiment shown in FIG. 3, section 300 includes a first overlay 308 disposed along first surface 304. Additionally, printing or marking can be provided on or along one or both of surfaces 304 and 306 of first layer 302. In the exemplary embodiment shown, printing 310 is disposed along first surface 304 and first overlay 308 extends across printing 310 substantially covering the same. As discussed above, such overlays are preferably formed from an approximately transparent material and are operative to protect the first layer as well as the printing.

Optionally, an information storage device can be provided on or along either one or both surfaces of the first layer. In the exemplary embodiment shown, a magnetic strip 312 is shown disposed along bottom surface 306. It will be appreciated, however, that any other suitable construction can alternately be used. Additionally, a second overlay (not shown) could optionally be provided and secured along second surface 306 of first layer 302. Such a second overlay would be operative to protect the second surface of the first layer, as well as protect any printing or marking that may be included along the second surface.

FIG. 4 is a cross-sectional side view of still another embodiment of a section of polymeric material 400 that is suitable for use as a sheet of plastic card stock or a plastic card. Section of polymeric material 400 includes a first layer 402 having a first or top surface 404 and an opposing second or bottom surface 406. In one exemplary embodiment, first layer 402 can be constructed of a material comprising recycled scrap material. In another embodiment, first layer 402 can be constructed of a material comprising a mixture of recycled scrap material and virgin polymeric material.

In the exemplary embodiment shown in FIG. 4, section 400 includes a first veneer 408 disposed along first surface 404 of first layer 402. Typically, the first veneer is included for informational or aesthetic purposes and, thus, includes printing or marking integrally formed thereon. However, first veneer 408 can optionally include an approximately transparent portion (not shown). Additionally, printing or other markings can be provided on or along one or both of surfaces 404 and 406 of first layer 402. In the exemplary embodiment shown, printing 410 is disposed along first surface 404 and first veneer 408 extends across printing 410 substantially covering the same.

Optionally, an information storage device can be provided on or along either one or both surfaces of the first layer. In the exemplary embodiment shown, a magnetic strip 412 is shown disposed along bottom surface 406. It will be appreciated, however, that any other suitable construction can alternately be used. Additionally, a second veneer (not shown) could optionally be provided and secured along second surface 406 of first layer 402. Such a second veneer may be disposed along the second surface to provide additional information or aesthetics, for example.

FIG. 5 is a cross-sectional side view of yet another embodiment of a section of polymeric material 500 that is suitable for use as a sheet of plastic card stock or a plastic card. Section of polymeric material 500 includes a first layer 502 having a first or top surface 504 and an opposing second or bottom surface 506. In one exemplary embodiment, first layer 502 can be constructed of a material comprising recycled scrap material. In another embodiment, first layer 502 can be constructed of a material comprising a mixture of recycled scrap material and virgin polymeric material.

In the exemplary embodiment shown in FIG. 5, section 500 includes a first veneer 508 disposed along first surface 504 and a first overlay 510 disposed along an outer surface 512 of first veneer 508. Typically, the first veneer is included for informational or aesthetic purposes and, thus, includes printing or marking (not shown) integrally formed thereon. However, first veneer 508 can optionally include an approximately transparent portion (not shown). Printing or other markings (not shown) can be provided on or along one or both of surfaces 504 and 506 of first layer 502.

Optionally, an information storage device can be provided on or along either one or both surfaces of the first layer. In the exemplary embodiment shown, a magnetic strip 514 is shown disposed along bottom surface 506. It will be appreciated, however, that any other suitable construction can alternately be used. Additionally, either one or both of a second veneer (not shown) and a second overlay (not shown) could optionally be provided and secured along second surface 506 of first layer 502. Such a second veneer, if provided, may be disposed along the second surface to provide additional information or aesthetics, for example. And, such a second overlay, if provided, may be disposed along the second surface or the second veneer to at least partially protect the same.

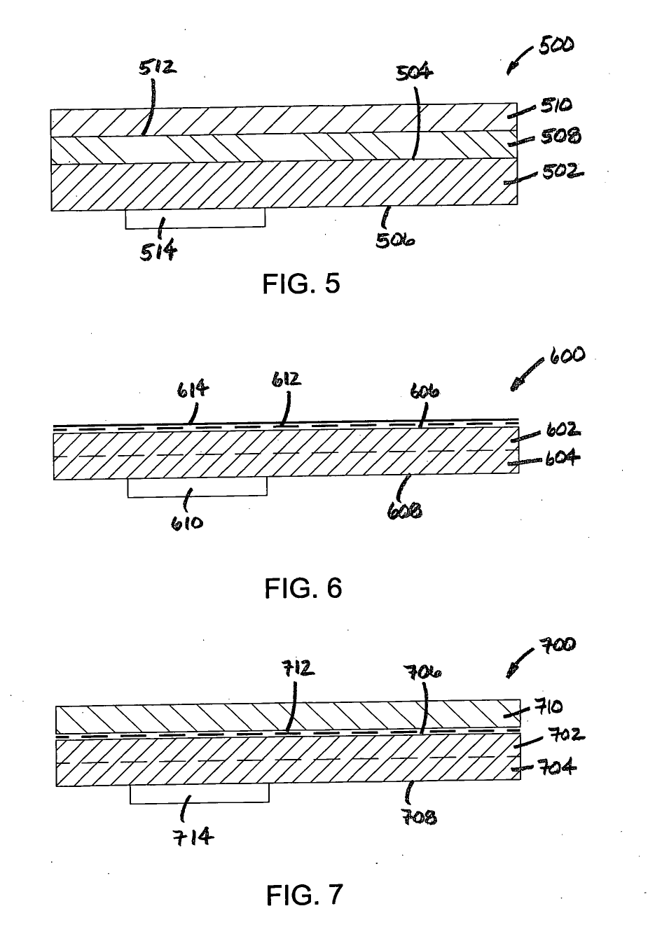

FIG. 6 is a cross-sectional side view of a further embodiment of a section of polymeric material 600 that is suitable for use as a sheet of plastic card stock or a plastic card. Section of polymeric material 600 includes a first layer 602, a second layer 604, a first or top surface 606, and an opposing second or bottom surface 608. In one exemplary embodiment, either one or both of first layer 602 and second layer 604 can be constructed of a material comprising recycled scrap material. In another exemplary embodiment, either one or both of first layer 602 and second layer 604 can be constructed of a material comprising a mixture of recycled scrap material and virgin polymeric material.

Optionally, an information storage device can be provided on or along either one or both surfaces of the section of polymeric material. In the exemplary embodiment shown, a magnetic strip 610 is shown disposed along bottom surface 608. It will be appreciated, however, that any other suitable construction can alternately be used. Additionally, printing or marking can be provided on or along one or both of surfaces 606 and 608 of section 602. In the exemplary embodiment shown, printing 612 is disposed along first surface 606. An optional clear coating 614, such as ink, lacquer or another suitable substance, for example, can be applied along one or both of surfaces 606 and 608. In one exemplary embodiment, such an optional clear coating 614 extends over any printing or marking that may be included, such as printing 612, for example.

FIG. 7 is a cross-sectional side view of a further embodiment of a section of polymeric material 700 that is suitable for use as a sheet of plastic card stock or a plastic card. Section of polymeric material 700 includes a first layer 702, a second layer 704, a first or top surface 706, and an opposing second or bottom surface 708. In one exemplary embodiment, either one or both of first layer 702 and second layer 704 can be constructed of a material comprising recycled scrap material. In another exemplary embodiment, either one or both of first layer 702 and second layer 704 can be constructed of a material comprising a mixture of recycled scrap material and virgin polymeric material.

In the exemplary embodiment shown in FIG. 7, section 700 includes a first overlay 710 disposed along first surface 706. Additionally, printing or marking can be provided on or along one or both of surfaces 706 and 708 of section 700. In the exemplary embodiment shown, printing 712 is disposed along first surface 706 and first overlay 710 extends across printing 712 substantially covering the same. As discussed above, such overlays are preferably formed from an approximately transparent material and are operative to protect the first layer as well as the printing.

Optionally, an information storage device can be provided on or along either one or both surfaces of the section of polymeric material. In the exemplary embodiment shown, a magnetic strip 714 is shown disposed along bottom surface 708. It will be appreciated, however, that any other suitable construction can alternately be used. Additionally, a second overlay (not shown) could optionally be provided and secured along second surface 708. Such a second overlay would be operative to protect the second surface of the first layer, as well as protect any printing or marking that may be included along the second surface.

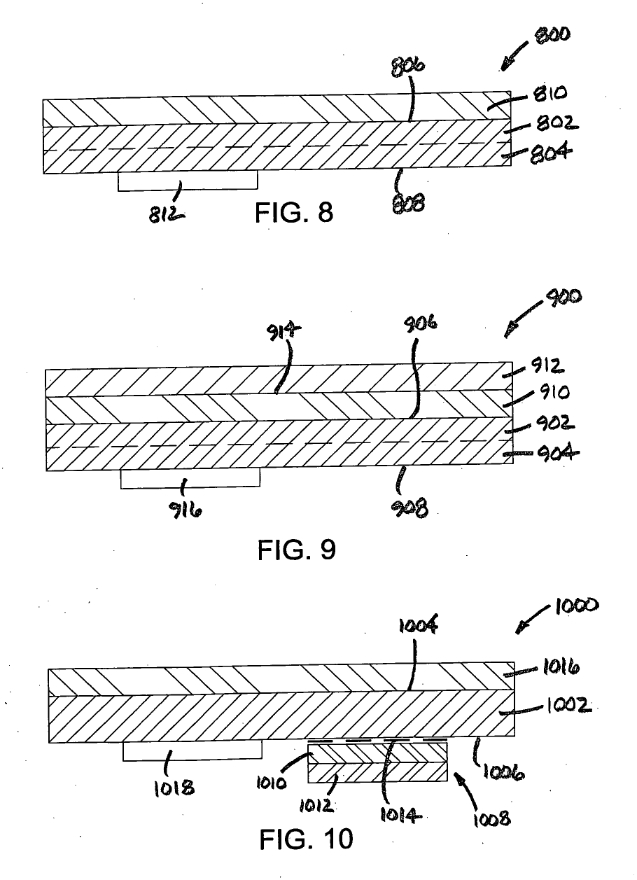

FIG. 8 is a cross-sectional side view of a further embodiment of a section of polymeric material 800 that is suitable for use as a sheet of plastic card stock or a plastic card. Section of polymeric material 800 includes a first layer 802, a second layer 804, a first or top surface 806, and an opposing second or bottom surface 808. In one exemplary embodiment, either one or both of first layer 802 and second layer 804 can be constructed of a material comprising recycled scrap material. In another exemplary embodiment, either one or both of first layer 802 and second layer 804 can be constructed of a material comprising a mixture of recycled scrap material and virgin polymeric material.

In the exemplary embodiment shown in FIG. 8, section 800 includes a first veneer 810 disposed along first surface 806. Typically, the first veneer is included for informational or aesthetic purposes and, thus, includes printing or marking integrally formed thereon. However, first veneer 810 can optionally include an approximately transparent portion (not shown). Additionally, printing or other markings (not shown) can be provided on or along one or both of surfaces 806 and 808 of section 800.

Optionally, an information storage device can be provided on or along either one or both surfaces of the section of polymeric material. In the exemplary embodiment shown, a magnetic strip 812 is shown disposed along bottom surface 808. It will be appreciated, however, that any other suitable construction can alternately be used. Additionally, a second veneer (not shown) could optionally be provided and secured along second surface 808. Such a second veneer may be disposed along the second surface to provide additional information or for aesthetic purposes, for example.

FIG. 9 is a cross-sectional side view of a further embodiment of a section of polymeric material 900 that is suitable for use as a sheet of plastic card stock or a plastic card. Section of polymeric material 900 includes a first layer 902, a second layer 904, a first or top surface 906, and an opposing second or bottom surface 908. In one exemplary embodiment, either one or both of first layer 902 and second layer 904 can be constructed of a material comprising recycled scrap material. In another exemplary embodiment, either one or both of first layer 902 and second layer 904 can be constructed of a material comprising a mixture of recycled scrap material and virgin polymeric material.

In the exemplary embodiment shown in FIG. 9, section 900 includes a first veneer 910 disposed along first surface 906 and a first overlay 912 disposed along an outer surface 914 of first veneer 910. Typically, the first veneer is included for informational, aesthetic or other purposes and, thus, normally includes printing or other markings (not shown) that are integrally formed thereon. However, first veneer 910 can optionally include an approximately transparent portion (not shown). Printing or other markings (not shown) can be provided on or along one or both of surfaces 906 and 908 of section 900.

Optionally, an information storage device can be provided on or along either one or both surfaces of the section of polymeric material. In the exemplary embodiment shown, a magnetic strip 916 is shown disposed along bottom surface 908. It will be appreciated, however, that any other suitable construction can alternately be used. Additionally, either one or both of a second veneer (not shown) and a second overlay (not shown) could optionally be provided and secured along second surface 908 of section 900. Such a second veneer, if provided, may be disposed along the second surface to provide additional information or aesthetics, for example. And, such a second overlay, if provided, may be disposed along the second surface or the second veneer to at least partially protect the same.

FIG. 10 is a cross-sectional side view of still another embodiment of a section of polymeric material 1000 that is suitable for use as a sheet of plastic card stock or a plastic card. Section of polymeric material 1000 includes a first layer 1002 having a first or top surface 1004 and an opposing second or bottom surface 1006. In one exemplary embodiment, first layer 1002 can be constructed of a material comprising recycled scrap material. In another embodiment, first layer 1002 can be constructed of a material comprising a mixture of recycled scrap material and virgin polymeric material.

An optional removable layer, such as a scratch-off label 1008, can be included on either one or both of surfaces 1004 and 1006. In the exemplary embodiment shown in FIG. 10, scratch-off label 1008 includes an approximately transparent polymeric layer 1010 and a removable opaque coating 1012 disposed along bottom surface 1006 of first layer 1002 overtop of transparent polymeric layer 1010. Generally, printing or markings will be provided on a surface of the section of polymeric material, such as printing 1014 disposed along bottom surface 1006, and scratch-off label 1008 will be disposed along the surface to obscure or hide the printing or markings. The printing or markings can be revealed by removing opaque coating 1012 of scratch-off label 1008.

Additionally, an optional veneer can be disposed along either one or both of surfaces 1004 and 1006. In the exemplary embodiment shown in FIG. 10, a first veneer 1016 is disposed along first surface 1004. Typically, the first veneer is included for informational, aesthetic or other purposes and, thus, normally includes printing or other markings (not shown) that are integrally formed thereon. However, first veneer 1016 can optionally include an approximately transparent portion (not shown). Additional printing or other markings (not shown) can optionally be provided on or along one or both of surfaces 1004 and 1006 of first layer 1002.

Optionally, an information storage device can be provided on or along either one or both surfaces of the section of polymeric material. In the exemplary embodiment shown, a magnetic strip 1018 is shown disposed along bottom surface 1006. It will be appreciated, however, that any other suitable construction can alternately be used.

Transparent polymeric layer 1010 can generally be made from any polymeric material including, polyesters, polystyrenes, polypropylene, polysulfone, alamide, polycarbonate, polyvinylalcohol, polyvinylchloride, and the like. In one preferred embodiment, polymeric layer 1010 is formed from the same family of polymeric material as the recycled scrap material or the virgin polymeric material. For example, a section of polymeric material can be constructed from a material comprising recycled PVC, and polymeric layer 1010 of the scratch-off label comprises PVC.

Removable opaque coating 1012 can be formed from any suitable material that can be removed or partially removed by scraping, scratching or another similar action. Materials suitable for use as a removable opaque coating are known in the art. Additionally, the removable opaque coating may be applied by any suitable method including, but not limited to, heat, pressure, adhesive, and the like.

It will be appreciated that any of the foregoing exemplary sections of polymeric material or others suitable for use in forming a sheet of plastic card stock or for use as plastic cards, including, without limitation, those described above with regard to FIGS. 2-10, may be constructed from a material comprising, consisting essentially of, or consisting of recycled polymeric scrap material. Additionally, it will be appreciated that the various constructions described herein can include one or more other devices or components of any suitable type or kind applied on or embedded therein, such as IC chips, for example.

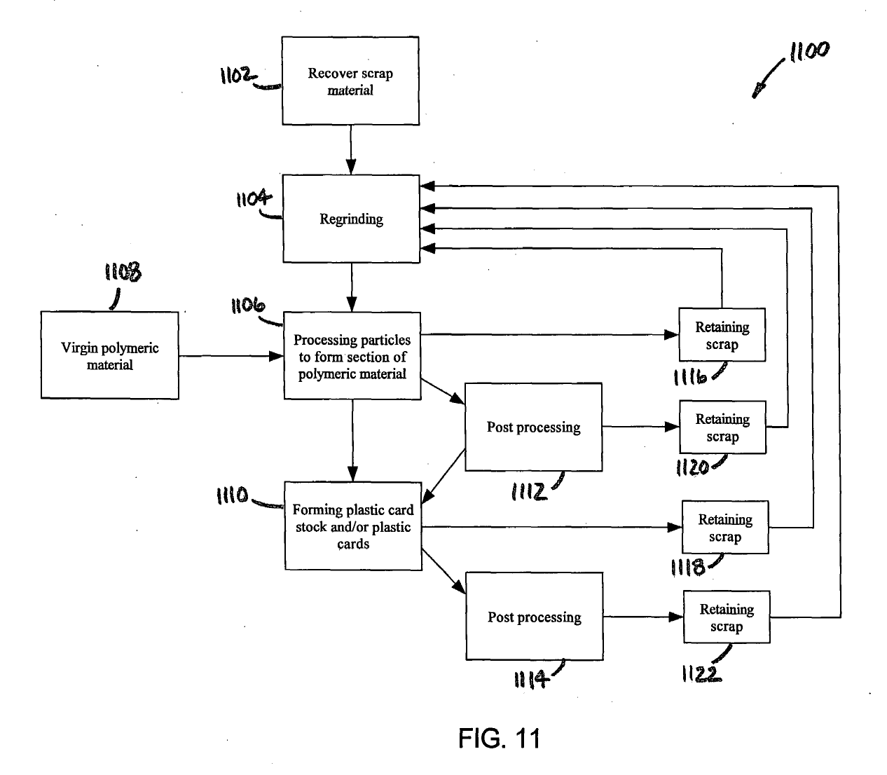

Turning now to FIG. 11, a method 1100 for manufacturing a section of polymeric material comprising recycled polymeric scrap material is provided that is suitable for use in forming a sheet of plastic card stock or for use as plastic cards. Method 1100 includes recovering scrap material from a source, as indicated by box 1102. Scrap material may be recovered from any suitable scrap polymeric material source or product that may be recycled to provide recycled scrap polymeric material suitable for use in manufacturing a plastic card.

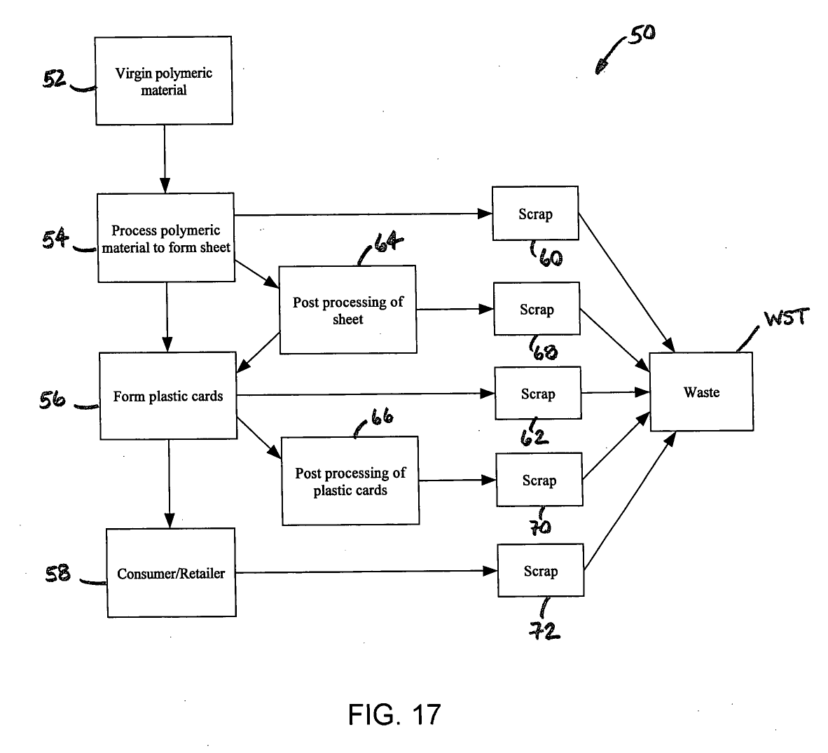

In one embodiment, polymeric scrap material is recovered from one or more plastic card stock and/or plastic card manufacturing processes. For example, as described above with reference to FIG. 17, scrap material such as scrap 60, 62, 68, 70 and/or 72 is produced at various processing steps including, for example, forming a plastic sheet, post processing of the plastic sheet, formation of the plastic cards, and/or post processing of the plastic cards. Thus, for example, scrap produced in a process in FIG. 17 may be recovered in accordance with the present novel concept, such as in box 1102 of method 1100, rather than simply being discarded as waste. Additionally or in the alternative, scrap material may be recovered from post-consumer scrap, e.g. discarded or used plastic cards, collected from retailers and/or directly from consumers (e.g., scrap 72 in FIG. 17). As such, the recovered scrap material may comprise a combination of scrap material recovered from a plastic card manufacturing process, post consumer scrap collected from retailers and/or customers, and/or other sources of scrap polymeric material.

As used herein, recovering scrap polymeric material includes any action to obtain scrap material including arranging or enabling others to deposit or collect scrap polymeric material. In one embodiment, recovering scrap polymeric material may include, for example, directly collecting scrap polymeric material from a source such as a retailer or consumer. In another embodiment, recovering scrap polymeric material may include arranging for a retailer to (i) collect cards after they have been used or discarded and (ii) provide those cards to the party who will use the scrap polymeric material to produce card stock or plastic cards from recycled polymeric scrap material. In still another embodiment, recovering scrap polymeric material may include arranging for post-consumer scrap to be collected such as, for example, providing receptacles at a selected location wherein consumers (including retailers) can deposit spent or used plastic cards.

As indicated in box 1104, method 1100 also includes regrinding the scrap polymeric material to produce scrap polymeric particles suitable for use in forming a section of polymeric material that is suitable for use in forming a sheet of plastic card stock or for use as plastic cards. As previously described, regrinding the recovered scrap material includes any method or process suitable for rendering the scrap polymeric material into particles having a particle size sufficient for use in a subsequent manufacturing processes, such as calendaring, extruding and/or co-extruding, for example. Examples of suitable regrinding methods include, but are not limited to, grinding, shredding, pulverizing, and the like.

The plastic particles produced by regrinding, which are now referred to herein as recycled polymeric scrap material, are then suitable for processing into a desired form. As indicated by box 1106, method 1100 includes processing the plastic particles into a section of polymeric material comprising recycled polymeric scrap material. The section can be formed using any suitable plastics processing method or operation, including continuous processes (e.g., extrusion) or non-continuous processes. Suitable plastics processing methods include, but are not limited to, calendaring, extrusion, co-extrusion, and the like.

As discussed above, sheets of plastic card stock and/or plastic cards comprising recycled scrap polymeric material may comprise a blend of recycled scrap material and virgin polymeric material. As such, method 1100 can optionally include, as indicated in box 1108, providing a quantity of virgin polymeric material and introducing the virgin polymeric material into the processing action in box 1106. This will blend the virgin polymeric material with the recycled polymeric scrap material in forming the section of polymeric sheet material.

Method 1100 also further includes forming a sheet of plastic card stock and/or plastic cards, as indicated by box 1110. Such an action can include any suitable methods, processes and/or operations, including, without limitation, cutting, trimming, shearing, punching, stamping, forming, molding, die cutting, or the like.

Furthermore, method 1100 can optionally include one or more post processing operations, as indicated by boxes 1112 and 1114. Such post processing operations can be performed approximately concurrently with or after forming the section of polymeric material in box 1106 and/or approximately concurrently with or after forming the sheet of plastic card stock or plastic cards in box 1110. Such post processing steps can include any suitable step or series of steps, such as, without limitation, personalization, printing, encoding a magnetic strip, embossing, and scoring, for example.

Method 1100 also optionally provides for in-process recycling of recycled polymeric scrap material. While polymeric scrap material recovered and provided in box 1102 may come from the processing of virgin polymeric materials, it will be appreciated that additional scrap from the already recycled polymeric scrap material will be produced at various steps throughout the process of forming a sheet of plastic card stock and/or a plastic card from the recycled polymeric scrap material. This additional scrap material can be recovered during processing by the manufacturer who can then regrind the scrap and process the reground particles to form a sheet and subsequently form plastic cards. Thus, method 1100 optionally includes retaining scrap, as indicated by box 1116, that is generated by processing the plastic particles into a section of polymeric sheet material in box 1106. Method 1100 can also optionally include retaining scrap, as indicated by box 1118, that is generated by forming a sheet of plastic card stock and/or a plastic card in box 1110. Additionally, method 1100 can optionally include retaining scrap, as respectively indicated by boxes 1120 and 1122, generated by any post processing operations in boxes 1112 and/or 1114.

In another embodiment, a method of manufacturing plastic cards can include one or more of the following steps: (i) recovering polymeric scrap material from a plastic card or a plastic card stock manufacturing process; (ii) grinding, shredding and/or pulverizing the recovered polymeric scrap material into a sufficiently fine particle size in order to render the scrap material fit for use in a subsequent calendaring, extrusion or co-extrusion process; (iii) processing the ground, shredded and/or pulverized scrap material to create a sheet of homogenous recycled scrap material; and (iv) punching a card out of the sheet. Optionally, the method can include the step of winding the sheet of homogenous recycled scrap material into a roll. The method can also optionally include the step of printing one or more characters, logos, or symbols on the sheet after steps (iii) or (iv) discussed above.

In still another embodiment, a method of manufacturing plastic cards includes one or more of the following steps: (i) recovering scrap material from a plastic card or a plastic card stock manufacturing process; (ii) grinding, shredding and/or pulverizing the scrap material into a sufficiently fine particle size in order to render the scrap material fit for use in a subsequent co-extrusion process; (iii) co-extruding the ground, shredded and/or pulverized scrap material with a veneer and/or an overlay to create a sheet of homogenous recycled scrap material with a veneer and/or an overlay; and (iv) punching cards out of the sheet. Optionally, the method can include the step of winding the sheet of homogenous recycled scrap material into a roll. The method can also optionally include the step of printing one or more characters, logos, or symbols on the sheet after steps (iii) or (iv) discussed above.

It is to be understood that the embodiments shown and described herein are merely exemplary and not intended to be limiting. Thus, it will be recognized that various constructions, steps, processes and operations disclosed herein can be combined in any configuration or order and that such combinations are intended to fall within the scope of the present disclosure. For example, in one embodiment, the source of the scrap material may be, all or in part, post-consumer scrap collected from retailers and/or directly from consumers. In another embodiment, virgin material may be blended with the ground, shredded or pulverized polymeric scrap material prior to or during a processing operation, such as a calendaring, extrusion or co-extrusion process, for example. In another embodiment the section of polymeric sheet material may be co-extruded to form two or more layers of recycled polymeric scrap material in a sheet or roll form. In yet another embodiment, the sheet of plastic card stock and/or plastic card can include one or more veneers and/or one or more overlays as well as contain any number of magnetic strips and/or printing or markings as may be desired.

Optionally, a manufacturer producing plastic card stock and/or plastic cards that comprises recycled scrap material may provide an indicia on the plastic card stock and/or plastic cards to identify or indicate that the manufacturer is the source of the card stock or plastic cards. Alternatively, or in addition to source identify indicia, a manufacturer may provide an indicia on the card stock or plastic cards to indicate the class, family, or type of polymeric material present in the card stock or plastic card. Indicia to identify the source and/or type of polymeric material may assist a manufacturer of cards comprising recycled scrap in recovering its own cards or cards of a particular material. This may also aid the recycling process and reduce the need to separate types or classes of polymeric materials from each other prior to processing. Indicia are not limited and may include printing, embossing, stamping or the like, in any shape, symbol, or pattern as desired.

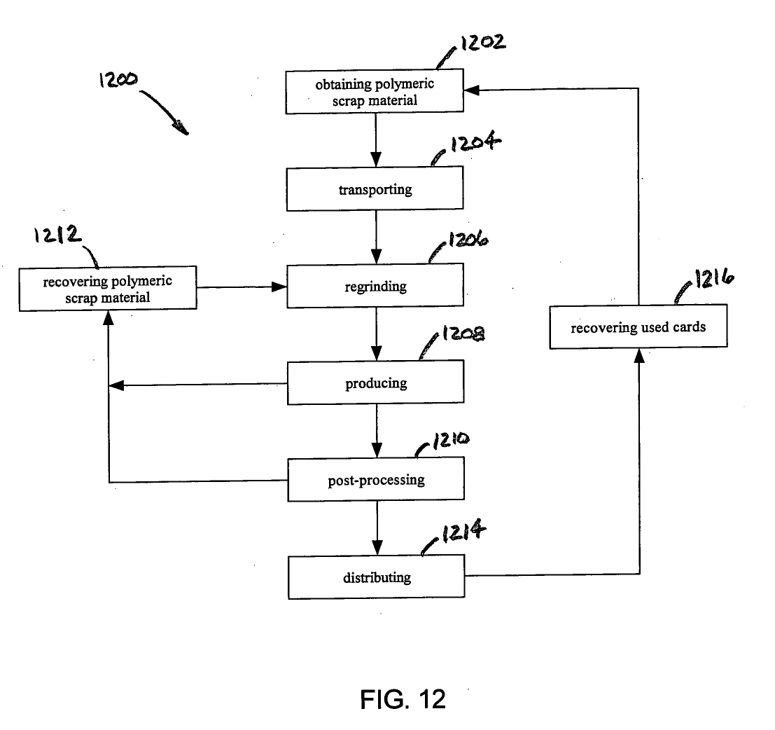

Turning now to FIG. 12, a method 1200 of recycling plastic cards formed from a material comprising recycled polymeric scrap material includes obtaining (which can include arranging for the obtainment of) polymeric scrap material from a third party source, as indicated in box 1202. Third party sources can include any party generating categorized scrap polymeric material, such as other plastic card manufacturers, as well as molders, extruders and other processors, for example. Method 1200 also includes transporting (which can include arranging for the transportation of) the polymeric scrap material to a facility for regrinding, as indicated in box 1204.

Method 1200 further includes regrinding (which can include arranging for regrinding of) the polymeric scrap material into suitably sized plastic particles, as indicated by box 1206. Though not shown in FIG. 12, method 1200 can optionally include transporting (which can include arranging for transportation of) the plastic particles or intermediate products formed therefrom to a facility for producing a sheet of plastic card stock or plastic cards. Method 1200 still further includes producing (which can include arranging for the production of) a sheet of plastic card stock or plastic cards formed from material comprising recycled polymeric scrap material, such as from the reground plastic particles, for example, as indicated by box 1208. Method 1200 optionally includes performing (which can include arranging for the performance of) one or more post-processing operations, as indicated by box 1210. A variety of exemplary post-processing operations have been discussed above and are not repeated here.

It will be appreciated that the production of a sheet of plastic card stock and/or plastic cards as well as the performance of post-processing operations, as indicated in boxes 1208 and 1210, respectively, will typically include a variety of processes and/or operation. The term post-processing as used herein includes performing (or arranging for the performance of) one or more post-processing operations suitable for use in forming plastic card stock or plastic cards. It will be further understood that many of such processes and/or operations may generate additional scrap material comprising the earlier obtained recycled polymeric scrap material. As such, method 1200 can optionally include recovering (which can include arranging for the recovery of) the additional polymeric scrap, as indicated in box 1212. Though not shown in FIG. 12, if such additional polymeric scrap material is recovered, method 1200 can optionally include transporting (which can include arranging for the transport of) the additional polymeric scrap material to a facility for regrinding. Such additional material can be thereafter reground, as indicated in box 1206, in conjunction with or in addition to other polymeric scrap materials, such as those provided in box 1202, for example.

Having produced sheets of plastic card stock and/or plastic cards, such as is indicated in boxes 1208 and/or 1210, method 1200 includes distributing (which can include arranging for the distribution of) the sheets of plastic card stock and/or plastic cards to third parties, such as card personalizers, distributors and/or retailers, for example, as indicated in box 1214. Method 1200 further includes recovering (which can include arranging for recovery of) used plastic cards from third parties, such as retailers and/or consumers, for example, as indicated in box 1216. Thus, the plastic cards formed originally from recycled polymeric scrap material can themselves become recycled polymeric scrap material used for the production of new plastic cards. This allows for recycled polymeric scrap material to be continuously recycled, which in turn will allow for the amount of virgin polymeric material used in the production of plastic cards to be reduced.

As previously described, scrap polymeric material can be recovered from any one of a variety of sources, such as by arranging for post-consumer scrap to be collected in a suitable manner. As one example, scrap polymeric material in the form of used plastic cards could be collected, such as by providing receptacles or containers at one or more locations for parties to deposit thereinto any spent or used plastic cards, for example. Such an arrangement could include, for example, arranging for a first party, such as a retailer, to (i) collect transaction cards having an approximately zero monetary value associated therewith after the same have been used or discarded by a second party, such as a customer, and (ii) provide the used transaction cards to a third party who will use the scrap polymeric material to produce recycled polymeric scrap material suitable for forming plastic card stock and/or plastic cards. For example, a retailer may collect cards in a manner they deem appropriate and then arrange to transport the cards to a party for recycling.

As an alternative, a recycler could provide a first party, such as a retailer, with a receptacle suitable for receiving and storing used transaction cards after the same have been collected from a second party, such as a customer. After the receptacle is full, or at a time preselected by the retailer or recycler, the collected plastic cards (with or without the receptacle) are transferred to a third party, such as a recycler, for example. The collected plastic cards (with or without the receptacle) can be transferred to in any suitable manner, such as by courier, mail or commercial shipping service (e.g., FEDERAL EXPRESS).

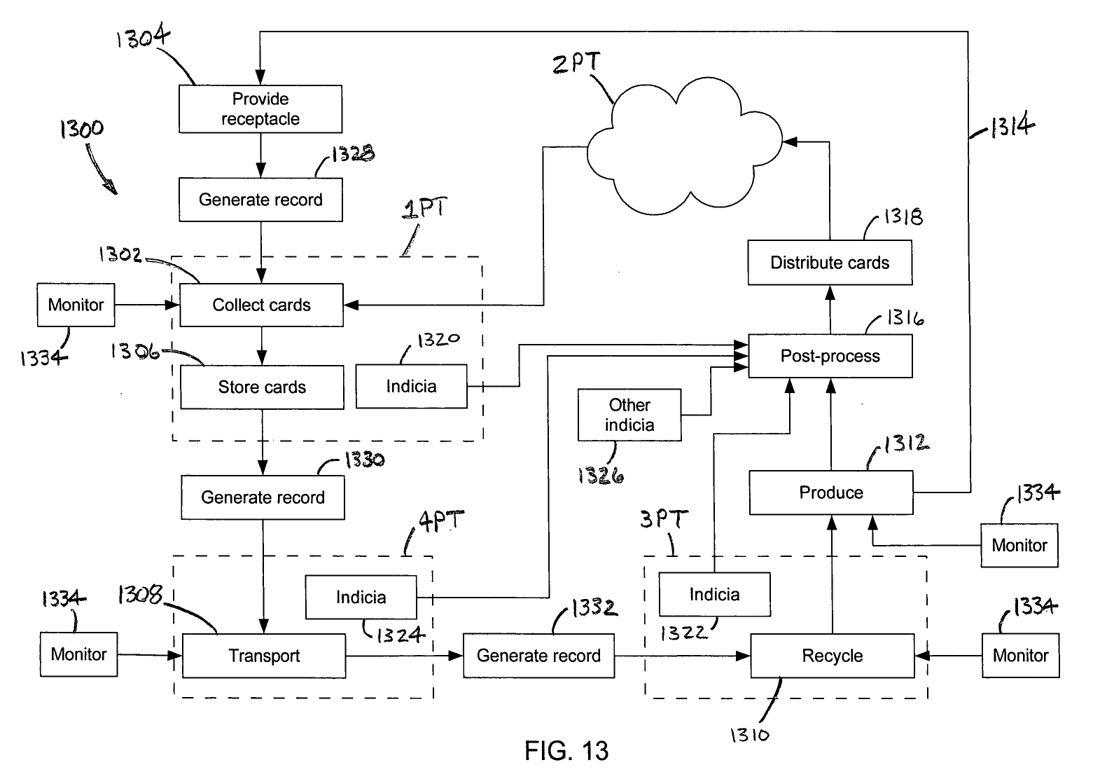

Turning now to FIG. 13, method 1300 provides another embodiment for recovering and/or recycling plastic cards, such as used transaction cards, for example. After a plastic card, such as a transaction card, for example, has been depleted, used, spent or is otherwise unwanted, such a plastic card will be well suited for recycling into material capable of use in forming new plastic cards. As such, method 1300 includes collecting (which can include arranging for collection of) used plastic cards, as indicated in box 1302. In one example, collecting used plastic cards can be performed by a first party 1PT, such as a retailer, for example. In such an example, the transaction card can be what is commonly referred to as a prepaid “gift” card. Such gift cards typically have a predetermined monetary value associated therewith, and a second party 2PT, such as a consumer, for example, can use the card to make purchases, often from a predefined retailer. Such a transaction card will normally be considered used when the second party (e.g., the consumer) has made purchases such that the predetermined monetary value associated with the card has a balance of about zero.

Such a used transaction card can be collected in any suitable manner at the location of first party 1PT. For example, the used transaction card could simply be retained by the first party after completion of a transaction with the second party. Alternately, the consumer might wish to recycle the used transaction card. As such, method 1300 can optionally include providing (which can include arranging for provision of) one or more receptacle or containers, as indicated in box 1304. Such a receptacle or container is preferably capable of receiving and storing a plurality of plastic cards. As such, method 1300 can optionally include storing plastic cards in a receptacle, as indicated in box 1306. While first party 1PT is shown in FIG. 13 as performing the action of storing the plastic cards, it will be appreciated that the first party, the second party or any other suitable party could alternately deposit spent cards into the receptacle. Of course, method 1300 is not limited to collecting or recovering used transaction cards, such as those with a zero or nearly zero balance. Rather, plastic cards with an associated monetary value that is greater than zero as well as other non-transaction cards (e.g., information and identification cards) can also be collected or otherwise recovered.

It will be appreciated that the first party, as it pertains to a method for reovering plastic cards, is not limited to retailers where transactions are made. Receptacles may be provided to any entity for placement at a selected location where it may be advantageous for consumers to deposit spent plastic cards. For example, transaction cards may be used to purchase goods online such that a consumer may not be at a retail location when a transaction card is reduced to an approximately zero balance. The consumer, however, may still wish to recycle the card rather than discard it. Thus, it may be desirable to arrange for receptacles to be placed in locations other than retail stores where a consumer can deposit the card for recycling. For example a recycler may provide one or more receptacles to cities or municipalities for placement at select locations to allow persons to deposit used cards at a time that is convenient for them.

Method 1300 also includes transporting (which can include arranging for transport of) any collected plastic cards from a location of the first party to a location of a third party 3PT for recycling, as indicated in by 1308. For example, such an action can further include arranging (which can include contracting) for a fourth party, such as a transport service, for example, to retrieve the collected plastic cards and deliver the collected plastic cards to the third party. Typically, the collected cards will be transported directly to a facility for regrinding of the same into recycled polymeric scrap material. As such, method 1300 includes recycling (which can include arranging for recycling of) the collected plastic cards into recycled polymeric scrap material suitable for forming into sheet material capable of use as plastic card stock and/or plastic cards, as indicated in box 1310. However, method 1300 contemplates that the collected plastic cards could be sent to any number of intermediate parties who will then forward the collected plastic cards to the third party (e.g., the recycler) for physical recycling of the collected plastic cards into recycled polymeric scrap material.

Optionally, the collected plastic cards could be transported in the receptacle in which the collected cards are stored. Additionally, the receptacle can optionally be formed from a material that is itself recyclable together with the collected plastic cards. Such an arrangement may be beneficial in minimizing the handling of the collected plastic cards themselves during the recycling process. For example, the receptacle could be formed from virgin PVC which would be recyclable with collected plastic cards from the PVC family. As another example, the receptacle could be formed from sheet material comprising recycled polymeric scrap material. That is, the receptacles or containers can be formed from at least some quantity of already recycled plastic cards. As such, method 1300 includes producing (which can include arranging for production of) sheet material capable of use in forming plastic card stock and/or plastic cards, as indicated in box 1312. It will be appreciated then that some of the sheet material can also be used to form containers or receptacles, as indicated by arrow 1314.

In one example of performing a method, an external party, such as independent contractor, for example, provides (which can include arranging for provision of) one or more receptacles to a first party, such as a retailer, and arranges for a fourth party to collect the receptacles and transport them to a third party. The independent contractor may have the fourth party transport the receptacles to (i) the independent contractor, who will then forward the receptacles to a facility for recycling, or (ii) directly to a facility for recycling. For purposes of this application such independent contractors are also considered a “recycler.”

In another example of performing a method, a recycler is engaged in one or more of (i) providing receptacles to a first party, and/or (ii) arranging with a fourth party to collect and deliver or otherwise transport the receptacles to the recycler.

In still another example of performing a method, arranging for transport of the receptacles includes making arrangements with the first party to directly transport a full receptacle to a facility for regrinding. In such an embodiment, the first party can agree to have the receptacle(s) transported by any method the first party finds acceptable. In another embodiment, arranging for collection and delivery of the receptacles includes contracting or partnering with a delivery or transport service, such as FEDERAL EXPRESS, for example, to collect the receptacles and deliver them to a third party, such as a recycler, who will facilitate regrinding the collected plastic cards to produce recycled polymeric scrap material.

Method 1300 optionally includes performing (which can include arranging for performance of) one or more post-processing operations, as indicated by box 1316, and distributing the sheets of plastic card stock and/or plastic cards to one or more parties, such as personalizers, distributors, and/or retailers, for example, as indicated in box 1318. The operations and/or actions corresponding to those indicated by boxes 1310, 1312, 1316 and 1318 have been discussed in detail above and are not repeated here. The cycle continues as distributed cards comprising recycled polymeric scrap material make their way into the hands of second parties 2PT and are used and once again collected, such as in receptacles at a first party location, for example, indicated in box 1302.

Optionally, method 1300 includes arranging for cards produced from recycled polymeric scrap material to be marked with an indicia identifying a partner in the collection, transportation and/or recycling of used plastic cards, such as are respectively illustrated in boxes 1302, 1308 and 1310 in FIG. 13. For example, arrangements could be made to have a plurality of plastic cards produced from recycled polymeric scrap material with the plastic cards being marked with indicia identifying one or more of the above-mentioned or other parties. First party 1PT, third party 3PT and fourth party 4PT are shown in FIG. 13 as having indicia 1320, 1322 and 1324 respectively associated therewith. Other indicia 1326 associated with other parties can also be utilized, such as in a manner discussed in greater detail hereinafter, for example, in marking cards with indicia. One or more of the parties could communicate an indicia respectively associated therewith for use in post-processing operations in box 1316 for inclusion on cards produced thereby. As a more specific example, a transport service acts as fourth party 4PT in a process of collecting used plastic cards and delivering the same to a recycler. As such, a plurality of plastic cards could be printed or otherwise marked with a representation of indicia 1324. In one embodiment, a recycler (i) arranges directly with a delivery or transport service to retrieve the collected plastic cards and deliver the same to the recycler for regrinding the cards, and (ii) arranges (which can include contracting) with the delivery service to have a plurality of plastic cards produced from plastic card stock comprising recycled polymeric scrap material and printed or otherwise marked with an indicia identifying or otherwise associated with the delivery service. Such an action could be considered as at least partial compensation to the transport service for its participation in the recycling program.

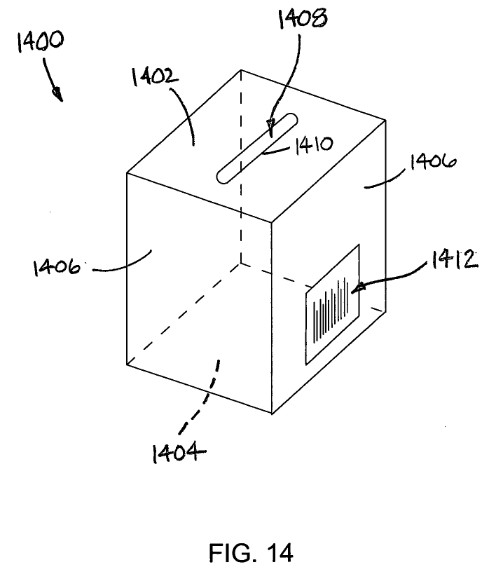

A receptacle suitable for receiving and storing used plastic cards, such as transaction, information and/or identification cards, for example, can be formed from any material suitable for a particular purpose and/or intended use. As such, receptacles could be formed from materials such as cardboard, plastic, wood, metal or any combination thereof, for example. One exemplary embodiment of a receptacle 1400 suitable for use in receiving and storing used plastic cards is shown in FIG. 14. Preferably, a suitable receptacle will include at least one wall that at least partially forms a storage chamber and at least one opening providing access to the storage chamber. In the embodiment in FIG. 14, receptacle 1400 includes a top 1402, a bottom 1404, and plurality of sides 1406 that together define a storage chamber 1408. A slot 1410 suitable for the passage of plastic cards therethrough is provided through top 1402. In one exemplary embodiment, receptacle 1400 is formed from a sheet material suitable for forming plastic card stock and/or plastic cards. Such sheet material can be formed from virgin polymeric material or alternately from recycled polymeric scrap material. By forming a receptacle from a material suitable for forming plastic card stock, the receptacle may also be subjected to regrinding and used to produce recycled scrap material. It will be appreciated, however, that receptacles may be reused as often as desired.

While receptacle 1400 is shown and described as being of a square or rectangular shape, it will be appreciated that receptacles can be provided in any shape desired for a particular purpose or intended use. Generally, a receptacle will be provided in the shape of a box comprising an opening through which a plastic card or cards may be deposited. In one embodiment, a receptacle is formed from a single sheet of plastic card stock; an opening is provided in the sheet, and the sheet is folded or manipulated as necessary to provide a receptacle of a desired shape.

Additionally, receptacles can be marked with one or more indicia of any suitable type, kind and/or configuration. As shown in FIG. 14, receptacle 1400 includes a receptacle indicia 1412 disposed along one of sides 1406. Furthermore, it will be appreciated that such indicia can be receptacle-specific indicia or alternately can be associated with an aspect or feature of the recycling program, such as a specific party, geographic location, size or shape of the receptacle, for example.

Returning to FIG. 13, method 1300 can optionally include generating one or more records associated with any suitable aspect, value, information or other detail of the recycling program. For example, method 1300 can optionally include generating a record that a receptacle was provided to a specific party, as indicated in box 1328. Such a record could include associating a specific detail of the receptacle with first party 1PT or could include associating a receptacle-specific indicia with the first party, for example. As another example, method 1300 can optionally include generating a record associated with the transport of collected plastic cards from one party to another, as indicated in box 1330. Such a record could include, for example, associating a quantity of cards collected and transported, the date of transport or any other aspects, values, details and/or information. As still another example, method 1300 can optionally include generating a record associated with the transport of collected plastic cards to a party, such as a third party recycler, for example, as indicated in box 1332. By generating records in this manner, the overall functioning of a plastic card recycling program as well as more specific aspects thereof can be monitored, as indicated in boxes 1334. Such monitoring may be useful to determine operational and/or performance details of a card recycling system, for example, and can be implemented in any suitable manner using any suitable hardware and/or software technology.

While being described with respect to recovering transaction cards, it will be appreciated that method 1300 is not limited to recovering only these types of cards, but may include recovering other types of plastic cards such as credit cards, bank cards, photo ID cards, and the like. Given that other types of cards may include sensitive, personal information, it may be desirable to provide a device to at least partially shred or otherwise destroy at least a portion of the card in an area near a receptacle. Alternatively, a receptacle may be provided with a device to at least partially shred or otherwise destroy at least a portion of a card and allow the remnants to pass into the collection area.

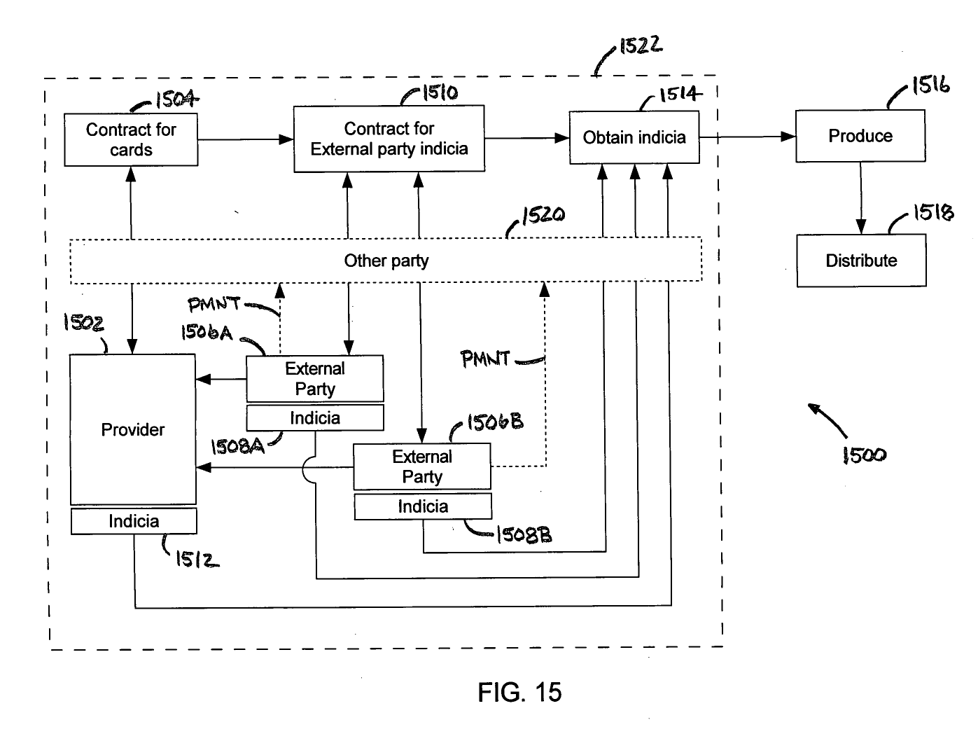

Turning now to FIG. 15, a method 1500 of presenting external-party indicia on transaction cards associated with a provider includes contracting (which include arranging for a contract) with a provider, such as provider 1502, for example, to supply thereto a plurality of transaction cards, as indicated in box 1504. Method 1500 also includes contracting (which can include arranging for a contract) with an external party, such as one or more of external parties 1506, for example, for an indicia 1508 associated with the external party to be provided on a plurality of transaction cards of provider 1502, as indicated in box 1510. In FIG. 15, two external parties 1506A and 1506B are shown and have indicia 1508A and 1508B respectively associated therewith.

Method 1500 further includes obtaining (which can include arranging for obtainment of) an indicia, such as indicia 1512, for example, from provider 1502 and obtaining (which can include arranging for obtainment of) an indicia 1508 from one or more of the contracting external parties 1506, as indicated in box 1514. Having obtained the indicia as indicated in box 1514, method 1500 includes producing (which can include arranging for production of), as indicated in box 1516, a plurality of transaction cards for provider 1502 and bearing indicia 1512 of the provider as well as bearing one or more of indicia 1508A and 1508B corresponding to any participating external parties 1506A and 1506B. It will be appreciated that producing or arranging for production of cards bearing the indicia can be performed in any suitable manner and using any suitable process. In many cases, however, such production is likely to occur during post-processing operations (e.g., personalizing, printing, encoding a magnetic strip, embossing, scoring), as discussed above. Method 1500 also includes distributing (which can include arranging for distribution of) the plurality of transaction cards to a party, such as provider 1502, for example.

It will be appreciated that any of the foregoing or other actions, including without limitation those actions represented by boxes 1504, 1510, 1514, 1516 and 1518, for example, can be executed, performed, arranged or otherwise attended to by any party or parties, either alone or in combination, that are participating or otherwise involved in providing external-party indicia on transaction cards of a provider. Examples of such parties include provider 1502, external parties 1506, a party involved in producing, distributing, validating and/or assigning a monetary value to the transaction cards, and/or any other party involved in producing, arranging for production or otherwise facilitating one or more aspects of the method. As one example, FIG. 15 includes other party 1520, such as an independent party or contractor, for example, that can arrange, facilitate or otherwise be involved in contracting with provider 1502, as indicated in box 1504, and contracting with external parties 1506A and 1506B, as indicated in box 1510. Other party 1520 can also optionally receive indicia 1508 and 1512 and communicate or arrange for communication of the indicia to one or more of the transaction card producers, such as parties associated with the actions represented by box 1516, for example.

It will also be appreciated that any contracts and/or agreements, such as could be established in the actions represented by boxes 1504 and 1510, for example, could include provisions in which the external-party indicia are included on the transaction cards of the provider in exchange for a compensation and that such a compensation can be provided in any manner or take any suitable form, such as the remittance of a fee, the application of a discount, or the covering of the cost of an expense, for example. Additionally, such a compensation can be paid, remitted or otherwise provided to any suitable party from or by any suitable party, such as any parties involved in or otherwise associated with the performance of any one or more of the actions associated with the subject method, including without limitation parties such as provider 1502, external parties 1506 and other party 1520, as well as parties associated with producing and/or distributing the transaction cards. As a more specific example, such a compensation could include the payment of a fee by the external parties directly to the provider in exchange for the inclusion of the external-party indicia on the transaction cards of the provider, with the provider then paying for the production and distribution of the transaction cards. As another example, such a compensation could include the payment of a fee by the external parties to other party 1520, as indicated in FIG. 15 by arrows PMNT, for example, or to the producer of the transaction cards. The fees would be of sufficient amount to cover the cost of producing and distributing the transaction cards. In this example, the transaction cards would be produced and distributed at no cost to the provider. It is to be understood that the foregoing compensation scenarios are merely examples of possible compensation arrangements and are not intended to be limiting.

It will be further appreciated that, in general, providers sell or otherwise provide goods and/or services that are supplied by certain external parties and which are purchased or otherwise obtained by other external parties. As a more specific example, a retailer of goods and/or services can be considered to be a provider, customers can be considered to be external parties that procure the goods and/or services sold or otherwise provided by the retailer, and third-party suppliers can be considered to be external parties that provide the goods and/or services that are sold by the retailer. Further to this example, retailers commonly have transaction cards produced that bear the name and logo of the retailer. Method 1500 can be employed in situations in which a given retailer desires or otherwise at least agrees to have transaction cards produced that bear not only the name and logo of that retailer but also bear indicia of one or more third-party suppliers to the retailer. As such, the retailer contracts for the provision of cards, as indicated in box 1504.

Having established that the retailer desires or otherwise at least agrees to have transaction cards produced that bear an indicia of one or more third-party suppliers, a contract or agreement can be established with one or more third-party suppliers, as indicated in box 1510, to provide their indicia on the transaction cards of the retailers in exchange for a compensation, such as a fee, for example. Any suitable compensation arrangement, such as have been described above, for example, can be used. Such one or more third-party suppliers can be represented by boxes 1506A and 1506B in FIG. 15, for example. It will be appreciated that the indicia of the third party suppliers can be of any suitable type, kind and/or configuration, such as a third-party supplier's name, logo or other associated mark. Method 1500 also includes obtaining a suitable indicia from the each of the third-party suppliers, as indicated in box 1514; producing, or having produced, retailer transaction cards bearing the indicia of one or more third-party suppliers, as indicated in box 1516; and, distributing the retailer transaction cards bearing the third-party supplier's indicia, as indicated in box 1518.

An example of a further method of providing advertising in the form of external-party indicia presented on transaction cards can include of otherwise be combined with a method of recycling plastic cards to generate transaction cards formed from recycled polymeric scrap material that includes external-party indicia presented thereon. In such a further example, the method described in FIG. 15 can be combined with the method described in FIG. 13 for recovering plastic cards. As such, a dashed box 1522 is provided in FIG. 15 and represents the parties, operations and/or actions involved in obtaining external party indicia for marking on transaction or other cards. The parties, operations and/or actions shown within box 1522 can be used to generate other indicia that can be input or otherwise utilized as other indicia 1326 in method 1300 of FIG. 13. It will be appreciated, however, that other exemplary methods and/or arrangements could also be utilized.

It will be appreciated that any party may contract or arrange with a given external party to have transaction cards produced for a provider that bear an indicia identifying the external party. In one embodiment, a retailer contracts with a third-party supplier to have the retailer's transaction cards bear an indicia identifying a third-party supplier. In another embodiment, a party contracting with the retailer to produce, or have produced, the retailer's transaction cards could contract (or arrange a contract) with a third-party supplier for the retailer's transaction cards to be produced bearing an indicia identifying the third-party supplier.

Additionally, it will be appreciated that a transaction card of a provider can be produced bearing the indicia of one, two, three, four, or more external parties, such as third-party suppliers, for example. Essentially, the number of external parties whose indicia may be marked on transaction cards of a provider is limited only by the size of the card and the smallest indicia size that the provider and/or external party deem acceptable. Further, the indicia of external party may be placed the front, the back or both the front and back of transaction cards of the provider.

Generally, it is anticipated that in method 1500 an external party, such as a third-party supplier, for example, will pay a compensation to at least one of the provider and/or the party contracting with the provider to produce, or have produced, the provider's transaction cards. In one exemplary embodiment, the compensation will be determined or otherwise established by factors such as the (i) size of the indicia of the external party, (ii) location in which the indicia of the external party is placed, and/or (iii) number of cards bearing the indicia of the external party. For example, an indicia having a first size covering a selected square area of the card may require a first fee. Generally, as the size of the indicia increases, the fee is expected to increase. Also, as the size of the indicia decreases, the fee decreases. The indicia size may be defined by any suitable means. In one embodiment, indicia size is measured by the square area of the card that the indicia occupies. As another example, a fee for placing indicia on the front of the card could be higher than a fee for placing the indicia on the back of the card. As a further example, various fees could be set based on both the indicia's size and location on the card. These examples are by no means meant to be limiting examples of the manner in which the fee for placing an indicia of an external party on a transaction card of a provider may be determined.

A provider may also arrange for various sets of transaction cards to be produced with each set of cards bearing different sets of external parties. A set of external parties comprises at least one external party. A card that is marked with indicia of a set of external parties includes indicia identifying each member in that set of external parties. Sets of external parties are different or not identical where one set includes at least one external party that is not a member of the other set. As a simple example, a first set of retailer's transaction cards may be produced bearing the indicia of a first third-party supplier, and a second set of the retailer's transactions cards may be produced bearing a second third-party supplier's indicia.

In one embodiment two sets of external parties, such as third-party suppliers, for example, may have no third-party suppliers in common. In another embodiment, different sets may have one or more third-party suppliers in common, but one set includes at least one third-party supplier that is not common to both sets. For example, two sets could each include five third-party suppliers; each set could contain four of the same third-party suppliers but a different fifth third-party supplier. As another example, a first set could contain five third-party suppliers and a second set could contain the same five third-party suppliers as the first set along with a sixth third-party supplier such that the second set contains a third-party supplier that is not a member of the first set, and therefore the second set is not identical to the first set. The above examples are non-limiting examples used for illustrating what may constitute non-identical sets of third-party suppliers.

Producing sets of cards with different sets of indicia allows retailers to contract with a number of different external parties, such as third-party suppliers, for example, to mark the retailer's transaction cards with third-party suppliers' indicia. It also allows third-party suppliers options in how they advertise. For example, a third-party supplier may only want to have their indicia placed on cards that will appear in only certain regions in a city, county, state, or other geographically determined area; or, a third-party supplier may want to limit the amount it spends on advertising by only having its indicia placed on a limited number of cards.

It will be appreciated that the party contracting with the retailer to produce, or have produced, the retailer's transaction cards is not limited. In one embodiment, the party contracting with a retailer is a recycler or party engaged in producing card stock and/or plastic cards from scrap material.

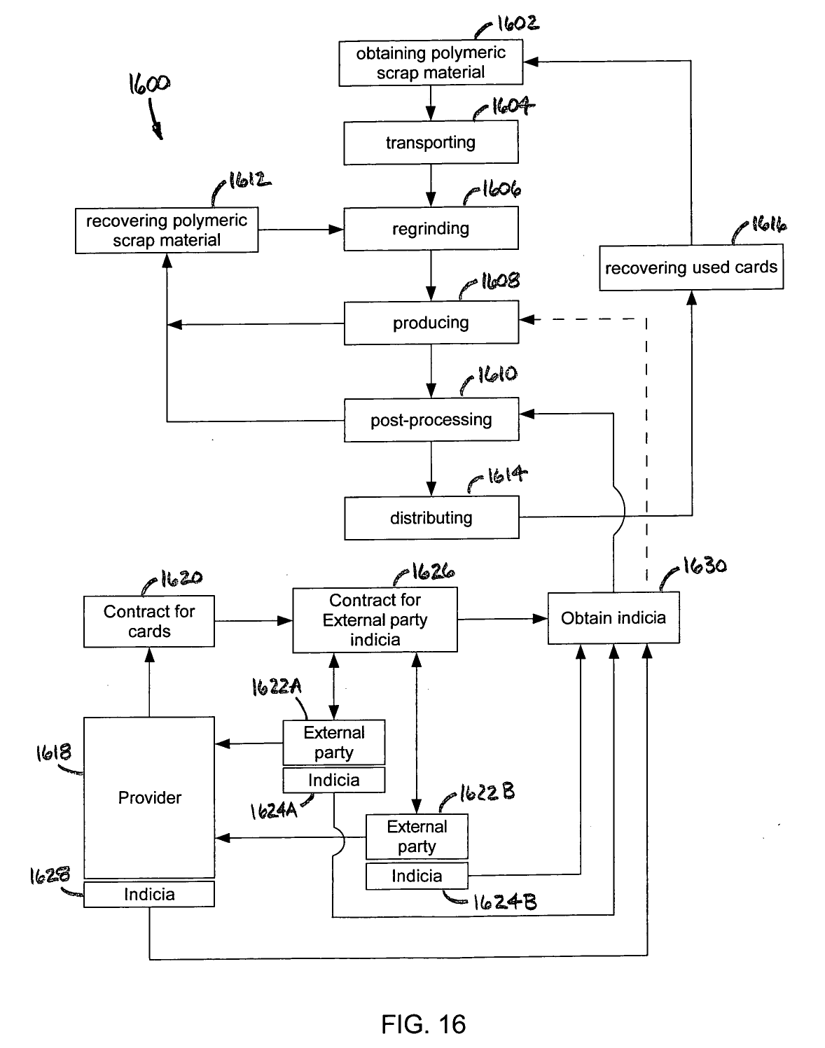

While not specifically referred to above, one embodiment of method 1500 can involve producing transaction cards from a material consisting essentially of virgin polymeric material. As an alternative, another embodiment of a method of providing advertising in the form of external-party indicia presented on transaction cards can include of otherwise be combined with a method of recycling plastic cards to generate transaction cards formed from recycled polymeric scrap material that include external-party indicia presented thereon. For example, in one embodiment, a method of providing advertisements on transaction cards that is similar to the method shown in and discussed with regard to FIG. 15 can be combined with a method of recycling plastic cards that is similar to the method shown in and discussed with regard to FIG. 12. Such an example is shown as method 1600 in FIG. 16 and includes actions and/or operations, as indicated in boxes 1602 through 1616, that are substantially similar to the actions and/or operations indicated in method 1200 of FIG. 12 in boxes 1202 through 1216 thereof. As such, a description of the actions and/or operations associated with boxes 1602-1616 is not repeated here. Method 1600 also includes parties, actions and/or operations, as indicated in boxes 1618 through 1630, that are substantially similar to the parties, actions and/or operations indicated in method 1500 of FIG. 15 in boxes 1502 through 1514 thereof. As such, a discussion of the parties, actions and/or operations associated with boxes 1618-1630 is not repeated here. It will be appreciated, however, that even though other party 1520 of FIG. 15 is not shown or otherwise represented in FIG. 16, the actions, arrangements and/or compensation scenarios discussed above with regard to other party 1520 are equally applicable to method 1600 and can optionally be included therein.

Rather than producing and distributing transaction cards as indicated in boxes 1516 and 1518 of method 1500 in FIG. 15, indicia obtained in box 1630 (which corresponds to box 1514 of method 1500) are utilized in post-processing operations, as indicated in box 1610, of the recycling operations embodied in boxes 1602-1616 of method 1600. Additionally, or in the alternative, the indicia obtained in box 1630 can be used in operations relating to the production of transaction cards in box 1608.

While specific reference is made herein to retailers and third-party suppliers to the retailers, it will be appreciated that the methods shown in and described with respect to FIGS. 13, 15 and 16 can additionally, or alternately, involve any other non-related entities, organizations and/or persons interested in advertising on a retailer's card.

Plastic cards constructed from a material comprising recycled scrap material, methods of forming such cards, methods for a process that continuously recycles scrap material, methods for recovering plastic cards, and methods for advertising on transaction cards, including on recycled transaction cards, have been described with reference to the various exemplary embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A method of recycling plastic cards, said method comprising:
a) arranging for a first party to collect used plastic cards from one or more second parties;
b) arranging for a transfer of said used plastic cards from said first party to a third party; and,
c) arranging for recycling of said used plastic cards into recycled polymeric scrap material by said third party.

2. A method according to claim 1 further comprising arranging with one of said third party and a fourth party for manufacturing of said recycled polymeric scrap material into sheet material capable of use as plastic card stock for forming new plastic cards.

3. A method according to claim 1 further comprising providing to said first party a container suitable for receiving and retaining plastic cards, and wherein a) includes arranging for said first party to retain said used plastic cards in said container.

4. A method according to claim 3, wherein providing said container includes providing a container formed from a material capable of being recycled together with said used plastic cards, b) includes arranging for a transfer of said used plastic cards and said container from said first party to said third party, and c) includes arranging for recycling of said plastic cards and said container into recycled polymeric scrap material.

5. A method according to claim 3, wherein providing said container includes marking said container with a container indicia and transferring said container with said container indicia to said first party.

6. A method according to claim 5 further comprising generating a record associating said container indicia with said first party.

7. A method according to claim 5 further comprising monitoring an aspect of at least one of collecting used plastic cards in a) or transferring said used cards from said first party to said third party in b) using said container indicia.

8. A method according to claim 7 further comprising generating a record having a relation to said aspect being monitored.

9. A method according to claim 1, wherein arranging for transfer of at least said used plastic cards in b) includes arranging for a fourth party to retrieve at least said used plastic cards from said first party and deliver at least said used plastic cards to said third party.

10. A method according to claim 9, wherein said fourth party has a fourth-party indicia, and said method further comprises arranging for said fourth-party indicia to be presented on a plurality of plastic cards comprising recycled polymeric scrap material as at least partial compensation to said fourth party for said retrieval and delivery thereby.

11. A method according to claim 1, wherein said first party is a retailer having a retail facility and a) includes collecting said used plastic cards at said retail facility.

12. A method according to claim 11, wherein said one or more second parties include one or more consumers patronizing said retail facility and at least partially compensating said retailer for at least one of goods or services using said plastic cards, and a) includes said retailer collecting plastic cards from said one or more consumers when said plastic cards are used plastic cards having approximately zero monetary value associated therewith.

13. A method of recycling used transaction cards, said method comprising:
a) one of providing and arranging for the provision of a card receptacle to a provider of at least one of goods or services, said card receptacle suitable for receiving and storing used transaction cards;
b) one of collecting and arranging for collection of at least one used transaction card from a purchaser of at least one of goods or services from said provider, said purchaser at least partially compensating said provider for said at least one of goods or services using a transaction card having non-zero monetary value associated therewith and thereby generating a used transaction card having an approximately zero monetary value associated therewith;
c) one of storing and arranging for storage of said at least one used transaction card in said card receptacle by said provider;
d) one of transporting and arranging for transportation by a transporter of said at least one used transaction card to a first recycler;
e) one of regrinding and arranging for regrinding of said at least one used transaction card into recycled polymeric scrap material by said first recycler; and,
f) one of processing and arranging for the processing by one of said first recycler or a second recycler of said recycled polymeric scrap material into polymeric sheet material capable of use in forming new plastic cards.

14. A method according to claim 13 further comprising:
g) one of processing and arranging for the processing of said polymeric sheet material into a plurality of plastic cards bearing an indicia of at least one of said provider, said transporter or said first recycler.

15. A method according to claim 13, wherein:
one of providing and arranging for provision of said card receptacle in a) includes one of providing and arranging for provision of a card receptacle formed from a material capable of being recycled together with said at least one used transaction card;
one of transporting and arranging for transportation of said at least one used transaction card in d) includes one of transporting and arranging for transportation of said at least one used transaction card and said card receptacle to said first recycler; and,
one of regrinding and arranging for regrinding of said at least one used transaction card in e) includes one of regrinding and arranging for regrinding of said at least one used transaction card and said card receptacle into recycled polymeric scrap material.

16. A method according to claim 15 further comprising one of processing and arranging for processing of a portion of said sheet material in f) into said card receptacle capable of being recycled together with said at least one transaction card.

17. A method according to claim 13 further comprising monitoring an aspect of at least one of said collecting in b), said transporting in d), said regrinding in e) or said processing in f), and generating a record having a relation to said aspect being monitored.

18. A method according to claim 17, wherein monitoring said aspect includes monitoring at least one of a quantity of used transaction card collected in b) or a weight having a relation to said used transaction cards transported in d).

19. A method according to claim 17, wherein one of providing and arranging for the provision of said card receptacle in a) includes one of associating and arranging for the association of a card-receptacle indicia with said card receptacle, and said method further comprises generating a record relating said card-receptacle indicia with at least one of said provider, said transporter or said first recycler.

20. A method according to claim 19, wherein generating a record having a relation to said aspect being monitored includes generating a record associating said aspect being monitored with a corresponding one of said provider, said transporter or said first recycler using said card-receptacle indicia.

21. A method of presenting external-party indicia on transaction cards associated with a provider of at least one of goods or services, said method comprising:
a) one of contracting and arranging a contract with a provider to supply thereto a plurality of transaction cards bearing an indicia of said provider and an indicia of an external party;
b) one of contracting and arranging a contract with an external party for presentation of an indicia associated with said external party on said plurality of transaction cards in exchange for compensation to at least one of said provider or a party associated with supplying said plurality of transaction cards to said provider;
c) one of producing and arranging for production of said plurality of transaction cards bearing said indicia of said provider and said indicia of said external party; and,
d) one of distributing and arranging for distribution of said plurality of transaction cards to at least said provider.

22. A method according to claim 21, wherein b) includes determining an amount of said compensation based on at least one of (i) location of said external-party indicia on said plurality of transaction cards, (ii) size of said external-party indicia, and/or (iii) a quantity of said plurality of transaction cards upon which said external-party indicia is presented.

23. A method according to claim 22, wherein determining said amount of said compensation includes determining said amount based on location of said external-party indicia on said plurality of transaction cards and said compensation for presenting said external-party indicia on a front side of said plurality of transaction cards is greater than said compensation for presenting said external-party indicia on a back side of said plurality of transaction cards.

24. A method according to claim 22, wherein determining said amount of said compensation includes determining said amount based on size of said external-party indicia on said plurality of transaction cards and said compensation increases as said size of said external-party indicia increases.

25. A method according to claim 21, wherein one of contracting and arranging a contract with said external party in b) includes one of contracting and arranging a contract with a third-party supplier of goods or services to said provider, and one of contracting and arranging a contract with said provider in a) includes one of contracting and arranging a contract with a retailer having a retail facility at which said goods or services of said third-party supplier are available to purchasers.

26. A method according to claim 25, wherein said one of producing and arranging for production of said plurality of transaction cards in c) includes one of producing and arranging for production of a plurality of transaction cards capable being adapted for use in purchasing said goods or services of said third-party supplier from said retailer.

27. A method according to claim 21, wherein said one of producing and arranging for production of said plurality of transaction cards in c) includes one of producing and arranging for production of a plurality of transaction cards formed from a material comprising recycled polymeric scrap material.

28. A method according to claim 21 further comprising:
e) one of collecting and arranging for collection of a plurality of used transaction cards by through said provider;
f) one of transferring and arranging for transfer of said plurality of used transaction cards from said provider to a first recycler; and,
g) arranging for recycling of said plurality of used transaction cards into recycled polymeric scrap material by said first recycler.

29. A method according to claim 28, wherein one of collecting and arranging for collection of said plurality of used transaction cards in e) includes one of collecting and arranging for collection of at least one used transaction card bearing at least one of said indicia of said provider or said indicia of said external party.

30. A method according to claim 28 further comprising one of manufacturing and arranging for manufacture of said recycled polymeric scrap material into sheet material by one of said first recycler and a second recycler, said sheet material being capable of use as plastic card stock for forming new plastic cards.

31. A method according to claim 30 further comprising one of supplying and arranging to supply said provider with a container suitable for receiving and retaining said used transaction card, and wherein e) includes one of retaining and arranging for retaining of said plurality of used transaction cards in said container.

32. A method according to claim 31, wherein one of supplying and arranging to supply said container includes one of supplying and arranging to supply a container formed from a material capable of being recycled together with said used transaction cards, f) includes one of transferring and arranging for transfer of said plurality of used transaction cards and said container from said provider to said first recycler, and g) includes arranging for recycling of said plurality of used transaction cards and said container into recycled polymeric scrap material.

33. A method according to claim 28, wherein one of transferring and arranging for transfer of said plurality of used transaction cards in f) includes one of transferring and arranging for transfer by a transporter capable of retrieving at least said plurality of used transaction cards from said provider and delivering at least said plurality of used transaction cards to said first recycler.

34. A method according to claim 33, wherein said transporter has a transporter indicia, and said method further comprises arranging for said transporter indicia to be presented on a plurality of transaction cards comprising recycled polymeric scrap material as at least partial compensation to said transporter for said retrieving and delivering of at least said plurality of used transaction cards.
